(19) United States
(12) Patent Application Publication
(10) Pub. No.: US 2016/0266521 A1
(43) Pub. Date: Sep. 15, 2016

(54) TONER, IMAGE FORMATION DEVICE, AND PROCESS CARTRIDGE

(71) Applicants: Ryota INOUE, Shizuoka (JP); Yoshihiro MORIYA, Shizuoka (JP); Masahiko ISHIKAWA, Shizuoka (JP); Satoshi TAKAHASHI, Kanagawa (JP); Tatsuki YAMAGUCHI, Shizuoka (JP)

(72) Inventors: Ryota INOUE, Shizuoka (JP); Yoshihiro MORIYA, Shizuoka (JP); Masahiko ISHIKAWA, Shizuoka (JP); Satoshi TAKAHASHI, Kanagawa (JP); Tatsuki YAMAGUCHI, Shizuoka (JP)

(21) Appl. No.: 15/035,786

(22) PCT Filed: Dec. 3, 2014
(86) PCT No.: PCT/JP2014/081965

§ 371 Date: May 11, 2016

(30) Foreign Application Priority Data
Dec. 5, 2013 (JP) 2013-252353

(51) Int. Cl. G03G 15/16; G03G 9/00; G03G 21/00

(52) U.S. Cl. CPC G03G 15/161; G03G 9/0819; G03G 9/0827; G03G 21/18

(57) ABSTRACT

A toner including a binder resin and a release agent, wherein the toner has a second peak particle diameter in a range of from 1.21 times through 1.31 times as large as a most frequent diameter in a volume basis particle size distribution, and wherein the toner has a particle size distribution (volume average particle diameter/number average particle diameter) in a range of from 1.08 through 1.15.

### TECHNICAL FIELD

The present invention relates to toners, image forming apparatuses, and process cartridges.

### BACKGROUND ART

Research and developments of electrophotography have been conducted with various inventive ideas and technical approaches.

In an electrophotographic process, a surface of a latent image bearer is charged and exposed to light to form an electrostatic latent image. The electrostatic latent image is developed with a color toner to form a toner image. Then, the toner image is transferred onto a transferred medium such as transferred paper and fixed by, for example, a heat roller to form an image.

An untransferred toner remaining on the latent image bearer is removed by, for example, a cleaning blade.

In recent years, electrophotographic color image forming apparatuses have broadly been employed, and digitized images are easily available. Thus, there is a need for images to be printed at higher definition.

Based on a study on images of higher resolution and gradation, a spherical toner was developed in order to faithfully reproduce an electrostatic latent image. The spherical toner has been researched to be further spheroidized and small-sized.

Toners produced by pulverizing methods have limitations in the above properties, i.e., sphericity and size. Therefore, so-called polymerization toners, which are capable of being spheroidized and small-sized, produced by a suspension polymerization method, an emulsion polymerization method or a dispersion polymerization method have been employed.

In the polymerization toner, deterioration of cleanability due to sphericity of the polymerization toner has become a problem.

That is, the spherical toner have problems that a toner remaining on the latent image bearer is difficult to remove to cause a charging roller to be contaminated, and the toner remaining on the latent image bearer causes image loss.

In recent years, there is a need for functional members to have longer service life so as to perform printing at a low cost. Among such members, a technique for prolonging the service life of the latent image bearer has been researched. However, it is necessary to overcome a problem of film abrasion due to frictions with a cleaning blade in order to prolong the service life of the latent image bearer. Therefore, there has not been developed a technique providing inexpensive electrophotography which maintains cleanability over a long period of time, prolongs the service life of the latent image bearer, and forms an image of good quality.

Meanwhile, there have been propositions to improve the cleanability. For example, there has been proposed a toner containing a binder resin, a colorant, and a silicone-oil-treated external additive (see, e.g., Patent documents 1 to 3).

However, referring to Examples of the Patent documents, the above proposed technique is unsatisfactory for providing inexpensive electrophotography which maintains cleanability over a long period of time, prolongs the service life of the latent image bearer, and forms an image of good quality because the external additive treated only with a silicone oil has limits to improve the cleanability of the spherical toner and reduce the film abrasion of the latent image bearer. The same applies to prolongation of the service life of an intermediate transfer member.

### CITATION LIST

### Patent Document

Patent document 1: Japanese Unexamined Patent Application Publication No. 2009-98194
Patent document 2: Japanese Unexamined Patent Application Publication No. 2002-148847
Patent document 3: Japanese Unexamined Patent Application Publication No. 2012-198525

### SUMMARY OF INVENTION

### Technical Problem

The present invention aims to solve the above existing problems and achieve the following objects. That is, the present invention has an object to provide a toner achieving inexpensive electrophotography which improves cleanability of a spherical toner in any environment, prolongs service life of a latent image bearer, and forms an image of good quality. The present invention also has an object to provide a toner achieving inexpensive electrophotography which improves cleanability of a spherical toner on an intermediate transfer member over a long period of time in any environment, prolongs service life of the intermediate transfer member, prevents a developing member from being contaminated, and forms an image of good quality.

### Solution to Problem

The means for solving the aforementioned problems are as follow. That is, a toner according to the present invention includes a binder resin and a release agent. The toner has a second peak particle diameter in a range of from 1.21 times through 1.31 times as large as a most frequent diameter in a volume basis particle size distribution of the toner. The toner has a particle size distribution (volume average particle diameter/number average particle diameter) in a range of from 1.08 through 1.15.

### Effects of Invention

The present invention can solve the above existing problems, and can provide a toner achieving inexpensive electrophotography which improves cleanability of a spherical toner in any environment, prolongs service life of a latent image bearer, and forms an image of good quality. The present invention can also provide a toner achieving inexpensive electrophotography which improves cleanability of a spherical toner on an intermediate transfer member over a long period of time in any environment, prolongs service life of the intermediate transfer member, prevents a developing member from being contaminated, and forms an image of good quality.

### BRIEF DESCRIPTION OF THE DRAWINGS

FIG. 1 is one exemplary photograph illustrating a state of a stopper layer formed on a front surface of a cleaning blade.

FIG. 2 is a conceptual view illustrating a state of one exemplary toner according to the present invention.

FIG. 3 is a view illustrating one exemplary image forming apparatus according to the present invention.

FIG. 4 is a view illustrating one exemplary soft roller fixing device containing a fluorine based-surface layer agent.

FIG. 5 is a schematic view illustrating one exemplary multi-color image forming apparatus.

FIG. 6 is a schematic view illustrating one exemplary revolver type-full color image forming apparatus.

FIG. 7 is a view illustrating one exemplary arrangement of a process cartridge.

FIG. 8 is a view illustrating one exemplary cleaning device used in an image forming apparatus according to the present invention.

FIG. 9 is a detailed explanatory view illustrating one exemplary cleaning portion of a cleaning device.

FIG. 10 is a detailed explanatory view illustrating one exemplary cleaning blade of a cleaning device.

FIG. 11 is cross-sectional view illustrating one exemplary arrangement of a liquid column resonance liquid droplet forming means.

FIG. 12 is cross-sectional view illustrating one exemplary arrangement of a liquid column resonance liquid droplet unit.

FIG. 13A is a schematic explanatory view illustrating standing waves of velocity and pressure fluctuations when a liquid column resonance liquid chamber is fixed at one end and N=1.

FIG. 13B is a schematic explanatory view illustrating standing waves of velocity and pressure fluctuations when a liquid column resonance liquid chamber is fixed at both ends and N=2.

FIG. 13C is a schematic explanatory view illustrating a standing wave of velocity and pressure pulsation when a liquid column resonance liquid chamber is free at both ends and N=2.

FIG. 13D is a schematic explanatory view illustrating standing waves of velocity and pressure fluctuations when a liquid column resonance liquid chamber is fixed at one end and N=3.

FIG. 14A is a schematic explanatory view illustrating standing waves of velocity and pressure fluctuations when a liquid column resonance liquid chamber is fixed at both ends and N=4.

FIG. 14B is a schematic explanatory view illustrating standing waves of velocity and pressure fluctuations when a liquid column resonance liquid chamber is free at both ends and N=4.

FIG. 14C is a schematic explanatory view illustrating standing waves of velocity and pressure fluctuations when a liquid column resonance liquid chamber is fixed at one end and N=5.

FIG. 15A is a schematic explanatory view illustrating a liquid column resonance phenomenon arising in a liquid column resonance flow path of a liquid droplet forming means.

FIG. 15B is a schematic explanatory view illustrating a liquid column resonance phenomenon arising in a liquid column resonance flow path of a liquid droplet forming means.

FIG. 15C is a schematic explanatory view illustrating a liquid column resonance phenomenon arising in a liquid column resonance flow path of a liquid droplet forming means.

FIG. 15D is a schematic explanatory view illustrating a liquid column resonance phenomenon arising in a liquid column resonance flow path of a liquid droplet forming means.

FIG. 15E is a schematic explanatory view illustrating a liquid column resonance phenomenon arising in a liquid column resonance flow path of a liquid droplet forming means.

FIG. 16 is a schematic view illustrating one exemplary toner producing apparatus.

FIG. 17 is a cross-sectional view illustrating another arrangement of a liquid column resonance liquid droplet forming means.

### MODE FOR CARRYING OUT THE INVENTION

### Toner

A toner according to the present invention contains a binder resin and a release agent, preferably contains an external additive, and, if necessary, further contains other components.

The toner has a second peak particle diameter in a range of from 1.21 times through 1.31 times, preferably in a range of from 1.25 times through 1.31 times as large as a most frequent diameter in a volume basis particle size distribution of the toner.

The toner has a particle size distribution (volume average particle diameter/number average particle diameter) in a range of from 1.08 through 1.15.

The toner has the second peak particle diameter in a range of from 1.21 times through 1.31 times as large as the most frequent diameter in the volume basis particle size distribution of the toner, so that toner particles, which tends to stagnate adjacent to a contact portion between a latent image bearer and a cleaning blade, are improved in flowability. Thus, a stick-slip phenomenon, which causes deterioration of cleanability, can be prevented from occurring, and excellent cleanability can be maintained.

The volume basis particle size distribution and the particle size distribution (volume average particle diameter/number average particle diameter) can be measured using a device for measuring a particle size distribution of toner particles by a coulter counter method. Examples of the device include COULTER COUNTER TA-II and COULTER MULTISIZER II (these products are of Beckman Coulter, Inc.).

A measurement method is as follows.

First, from 0.1 mL through 5 mL of a surfactant (preferably alkylbenzene sulfonate) serving as a dispersant is added to from 100 mL through 150 mL of an electrolyte solution.

Here, the electrolyte solution is an about 1% aqueous NaCl solution prepared using 1st grade sodium chloride, and ISOTON-II (product of Coulter, Inc.) is used as the electrolyte solution.

Subsequently, a measurement sample (solid content: from 2 mg through 20 mg) is added to and suspended in the electrolyte solution.

The resultant electrolyte solution is dispersed with an ultrasonic disperser for from about 1 min through about 3 min, followed by analyzing with the above-described device (COULTER COUNTER TA-II or COULTER MULTISIZER II) using an aperture of 100 μm to measure the number and volume of the toner particles or the toner. Based on the number and the volume, a volume distribution (volume basis particle size distribution) and a number distribution are calculated.

From thus-obtained distributions, the volume average particle diameter (Dv) and the number average particle diameter (Dn) of the toner are determined.

In a preferable aspect of the present invention, a silicone-oil-treated silica serving as the external additive forms a stopper layer on the latent image bearer. This stopper layer enables a spherical toner to be further cleaned.

In a preferable aspect of the present invention, the toner contains a certain amount of a free silicone oil, so that rubbing force between the latent image bearer and the cleaning blade is reduced. Thus, a surface layer of the latent image bearer can be prevented from being abraded, enabling the latent image bearer to have more prolonged service life.

### <Binder Resin>

The binder resin is not particularly limited and may be appropriately selected depending on the intended purpose. Examples of the binder resin include a polyester resins, styrene-acryl resins, polyol resins, vinyl resins, polyurethane resins, epoxy resins, polyamide resins, polyimide resins, silicon resins, phenol resins, melamine resins, urea resins, aniline resins, ionomer resins, and poly carbonate resins. Of these, preferable are the polyester resins, and particularly preferable are modified polyester resins and polyester resins which have not modified (unmodified polyester resins) from the viewpoint of fixability.

### <<Polyester Resin>>

Examples of the polyester resin include polycondensates of polyols and polycarboxylic acids, ring-opening polymers of lactones, and polycondensates of hydroxycarboxylic acids. Of these, preferable are the polycondensate of polyols and polycarboxylic acids from the viewpoint of flexibility in design.

A ratio of the polyol to the polycarboxylic acid is preferably from 2/1 through 1/1, more preferably from 1.5/1 through 1/1, particularly preferably from 1.3/1 through 1.02/1, in terms of an equivalent ratio [OH]/[COOH] of a hydroxyl group [OH] to a carboxyl group [COOH].

The polyester resin preferably has a mass average molecular weight in a range of from 5,000 through 50,000, more preferably in a range of from 10,000 through 30,000, particularly preferably in a range of from 15,000 through 25,000.

The polyester resin preferably has a glass transition temperature in a range of from 35° C. through 80° C., more preferably in a range of from 40° C. through 70° C., particularly preferably in a range of from 45° C. through 65° C. The glass transition temperature of 35° C. or more can prevent the toner from deforming under a high temperature environment such as in midsummer, or can prevent the toner particles from adhering to each other, to enable the toner particles to behave as particles. The glass transition temperature of 80° C. or less results in excellent fixability.

### —Modified Polyester Resin—

By using the modified polyester resin as the polyester resin, the toner can have an appropriate degree of cross-linked structure. The modified polyester resin is not particularly limited and may be appropriately selected depending on the intended purpose, so long as modified polyester resin contains at least one of a urethane bond and a urea bond. The modified polyester resin is preferably a resin obtained through at least one of an elongation reaction and a cross-linking reaction between an active hydrogen group-containing compound and a polyester resin containing a functional group reactive with an active hydrogen group of the active hydrogen group-containing compound (hereinafter may be referred to as “prepolymer”).

### —Crystalline Polyester Resin—

The toner may contain a crystalline polyester resin as the polyester resin for the purpose of improving low temperature fixability. The crystalline polyester resin is also obtained as the polycondensate between the polyol and the polycarboxylic acid as described above. The polyol is preferably an aliphatic diol. Specific examples of the aliphatic diol include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, and 1,4-butenediol. Of these, preferable are 1,4-butanediol, 1,6-hexanediol, and 1,8-octanediol, and more preferable is 1,6-hexanediol.

The polycarboxylic acid is preferably an aromatic dicarboxylic acid (e.g., phthalic acid, isophthalic acid, and terephthalic acid) or an aliphatic carboxylic acid having from 2 through 8 carbon atoms. Of these, more preferable is an aliphatic carboxylic acid for increasing the degree of crystallinity.

Notably, a crystalline resin (crystalline polyester) and a non-crystalline resin are distinguished from each other based on thermal properties. The crystalline resin refers to, for example, a resin having a clear endothermic peak in a DSC measurement, such as wax.

The non-crystalline resin refers to a resin exhibiting a gentle curve based on glass transition.

### <Release Agent>

The release agent is not particularly limited and may be appropriately selected depending on the intended purpose. Examples of the release agent include polyolefin waxes (e.g., polyethylene waxes and polypropylene waxes); long chain-hydrocarbons (e.g., paraffin waxes, Fischer-Tropsch waxes and SASOL waxes); and carbonyl group-containing waxes.

Examples of the carbonyl group-containing waxes include polyalkanoic acid esters (e.g., carnauba waxes, montan waxes, trimethylolpropane tribehenate, pentaerythritol tetrabehenate, pentaerythritol diacetatedibehenate, glycerine tribehenate, and 1,18-octadecanediol distearate); polyalkanol esters (e.g., tristearyl trimellitate and distearyl maleate); polyalkanoic acid amides (e.g., ethylenediamine dibehenylamide); polyalkylamides (e.g., tristearylamide trimellitate); dialkyl ketones (e.g., distearyl ketone); and mono- or di-esters.

An amount of the release agent is not particularly limited and may be appropriately selected depending on the intended purpose, but is preferably in a range of from 4% by mass through 15% by mass, more preferably in a range of from 5% by mass through 10% by mass relative to the mass of the toner. When the amount of the release agent is less than 4% by mass, a release property of the toner from a fixing means cannot be ensured, potentially leading to offset, and thus image failure. When the amount of the release agent is more than 15% by mass, a large amount of the release agent is present on a surface of the toner, causing a developing member to be contaminated. As a result, image failure such as white blank in a contaminated portion may be occurred.

### <External Additive>

The external additive is not particularly limited and may be appropriately selected depending on the intended purpose, but is preferably treated with a silicone oil.

The external additive preferably contains inorganic particles.

### <<Silicone Oil>>

Examples of the silicone oil include dimethyl silicone oils (e.g., polydimethyl siloxane (PDMS)), methylphenyl silicone oils, chlorophenyl silicone oils, methylhydrogen silicone oils, alkyl modified-silicone oils, fluorine modified-silicone oils, polyether modified-silicone oils, alcohol modified-silicone oils, amino modified-silicone oils, epoxy modified-silicone oils, epoxy/polyether modified-silicone oils, phenol modified-silicone oils, carboxyl modified-silicone oils, mercapto modified-silicone oils, acryl modified-silicone oils, methacryl modified-silicone oils, and α-methylstyrene modified-silicone oils.

### <<Inorganic Particles>>

Examples of a material of the inorganic particles include silica, alumina, titania, barium titanate, magnesium titanate, calcium titanate, strontium titanate, iron oxide, copper oxide, zinc oxide, tin oxide, silica sand, clay, mica, wollastonite, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The inorganic particles are preferably at least one selected from the group consisting of silica particles, titania particles, and alumina particles, more preferably the silica particles from the viewpoint of achieving appropriate developability.

A primary average particle diameter of the external additive is not particularly limited and may be appropriately selected depending on the intended purpose, but is preferably in a range of from 30 nm through 150 nm, more preferably in a range of from 30 nm through 100 nm. When the primary average particle diameter is larger than 150 nm, a surface area of the external additive is decreased and the total amount of the silicone oil carried on the external additive is also decreased. Thus, an effect of the free silicone oil may become less likely to be exhibited. When the primary average particle diameter is smaller than 30 nm, the external additive becomes less likely to separate from the toner, so that the stopper layer necessary for cleaning may be difficult to form.

The average primary particle diameter of the external additive can be measured by, for example, a device for measuring a particle diameter distribution utilizing dynamic light scattering (e.g., DLS-700 (product of Otsuka Electronics Co., Ltd.) or COULTER N4 (product of Beckman Coulter, Inc.).

However, the particle diameter is preferably determined directly from a photograph taken by a scanning electron microscope or a transmission electron microscope, because secondary aggregates of silicone-oil-treated particles are difficult to separate from each other.

A BET specific surface area of the external additive is not particularly limited and may be appropriately selected depending on the intended purpose, but is preferably in a range of from 10 m²/g through 50 m²/g from the viewpoint of achieving good cleanability. When the BET specific surface area is less than 10 m²/g, the total amount of the silicone oil carried on the external additive may be decreased. When the BET specific surface area is more than 50 m²/g, the stopper layer necessary for cleaning may be difficult to be formed.

The BET specific surface area of the external additive can be measured using a surface area analyzer AUTOSORB-1 (product of Quantachrome Instruments) as follows.

About 0.1 g of a measurement sample is weighed into a cell, and degassed at a temperature of 40° C. and the degree of vacuum of 1.0×10⁻³ mmHg or lower for 12 hours or longer.

Then, nitrogen gas is allowed to be adsorbed on the sample while cooling with liquid nitrogen, and the value of the BET specific surface area is determined by a multi-point method.

A total amount of the free silicone oil in the toner is not particularly limited and may be appropriately selected depending on the intended purpose, but is preferably in a range of from 0.20% by mass through 0.50% by mass from the viewpoint of improved cleanability and reduced film abrasion amount of the latent image bearer.

The free silicone oil is not necessarily chemically bonded to surfaces of the inorganic particles, and includes silicone oil which is physically adsorbed on pores on surfaces of the inorganic particles.

More specifically, the free silicone oil refers to a silicone oil which is easily detached from the inorganic particles by the action of contact force. A method for measuring the free silicone oil will be described below (see the section “Method for measuring amount of free silicone oil”).

A method for treating the inorganic particles with the silicone oil to obtain the external additive may be, for example, as follows.

The silicone oil is uniformly brought into contact with the inorganic particles, which have been previously sufficiently dehydrated and dried in an oven at a temperature of several hundred degrees Celsius, to deposit the silicone oil on surfaces of the inorganic particles.

Examples of a method for depositing the silicone oil on the inorganic particles include a method in which powdered inorganic particles are sufficiently mixed with the silicone oil by means of a mixer such as a rotating blade; and a method in which the silicone oil is dissolved in a solvent capable of diluting the silicone oil and having a relatively low boiling point, and then powdered inorganic particles are immersed in the resultant solution, followed by drying to remove the solvent.

When the silicone oil has high viscosity, the inorganic particles are preferably treated in a liquid.

Then, the powdered inorganic particles on which the silicone oil has been deposited are subjected to a heat treatment in an oven at a temperature in a range of from 100° C. to several hundred degrees Celsius. As a result, the silicone oil can be bound to a metal through a siloxane bond using hydroxyl groups on surfaces of the inorganic particles, or the silicone oil itself can be further polymerized or cross-linked.

An amount of the silicone oil contained in the external additive is preferably in a range of from 2 mg through 10 mg per m² of surface area of the external additive.

When the amount is less than 2 mg, a preferable amount of the free silicone oil cannot be contained in the toner, so that the desired cleanability may not be attained. When the amount is more than 10 mg, an amount of the free silicone oil in the toner becomes excessively large. As a result, filming on the latent image bearer or the developing member is caused, potentially leading to image failures.

The silicone oil may be acceleratedly reacted by adding a catalyst (e.g., acid, alkali, a metal salt, zinc octylate, tin octylate, and dibutyltin dilaurate) to the silicone oil in advance.

Moreover, the inorganic particles may be treated with a hydrophobizing agent (e.g., a silane coupling agent) in advance prior to treatment with the silicone oil. The silicone oil is adsorbed on inorganic powder which has been hydrophobized in a larger amount than on unhydrophobized inorganic powder.

Action and effect of the free silicone oil in the present invention will now be described.

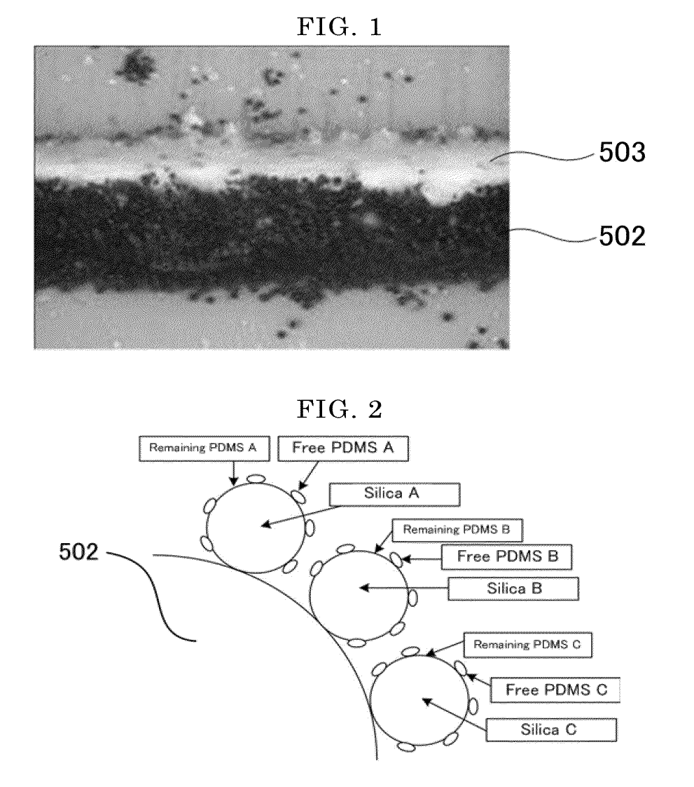

FIG. 1 is a photograph taken adjacent to the cleaning blade after image formation with the toner containing the silicone-oil-treated silica.

At a front surface of the cleaning blade, a stopper layer 503 is formed of the silicone-oil-treated silica between a toner 502 and the cleaning blade. This stopper layer 503 prevents the toner from passing-through the cleaning blade.

A certain amount of the free silicone oil reduces the rubbing force between the latent image bearer and the cleaning blade, and therefore can prevent the surface layer of the latent image bearer from being abraded.

FIG. 2 is a conceptual diagram illustrating a state of one example of the toner 502.

Silica particles (Silica A, Silica B, and Silica C) serving as the external additive are externally added on a surface of a toner particle. On a surface of each of these silica particles, there are an unfree silicone oil (remaining PDMS-polydimethyl siloxane) and a free silicone oil (free PDMS-polydimethyl siloxane).

A total amount of the free PDMS in the silicone-oil-treated silica and a total amount of the free PDMS in the toner are represented as follows:

Total amount of free PDMS in silicone-oil-treated silica=amount of free PDMS (A)+amount of free PDMS (B)+amount of free PDMS (C); and

Total amount of free PDMS in toner=100×[amount of free PDMS (A)+amount of free PDMS (B)+amount of free PDMS (C)]/amount of toner;

where [amount of free PDMS (A)], [amount of free PDMS (B)], and [amount of free PDMS (C)] denote amounts of free PDMS in each silica particle.

The free silicone oil is a portion of the silicone oil, which can be removed by chloroform, and this portion can be removed by external contact or external stress.

A remaining silicone oil is a portion of the silicone oil, which cannot be removed by chloroform, and this portion cannot be removed by external contact or external stress.

The removed silicone oil is moved to the latent image bearer and an intermediate transfer member to contribute to reduction of friction with the cleaning blade.

As a result, vibration caused by the cleaning blade is suppressed, and a space formed between the latent image bearer or the intermediate transfer member and the cleaning blade at the time of vibration is decreased, so that the toner having high circularity can be cleaned.

### <<Method for Separating External Additive in Toner>>

Two grams of the toner is added into 30 mL of a surfactant solution (10-fold diluted), and mixed together sufficiently. Then, the toner is separated by applying energy at 40 W for 5 min using an ultrasonic homogenizer, followed by cleaning and then drying. Thus, the external additive is separated from the toner. Thus-separated external additive is used as a sample to measure an amount of the free silicone oil in the external additive by the following method.

### <<Method for Measuring Amount of Free Silicone Oil>>

A free silicone oil amount (amount of free silicone oil) is measured by a quantitative method including the following steps (1) to (3):

(1) A sample for extracting the free silicone oil is immersed in chloroform, stirred, and left to stand.
A supernatant is removed by centrifugation to obtain a solid content. Chloroform is added to the solid content, stirred, and left to stand.
The above procedures are repeated to remove the free silicone oil from the sample.
(2) Quantification of carbon content
A carbon content in the sample from which the free silicone oil has been removed is quantified by a CHN elemental analyzer (CHN CORDER MT-5; product of Yanaco Technical Science Co., Ltd.).
(3) A quantitative amount of the free silicone oil is calculated by the following Expression (1):

Amount of free silicone oil=(C₀−C₁)/C×100×40/12 (% by mass) Expression (1)

where
“C” denotes a carbon content (% by mass) in the silicone oil serving as a treating agent,
“C₀” denotes a carbon content (% by mass) in the sample before the extraction,
“C₁” denotes a carbon content (% by mass) in the sample after the extraction, and
the coefficient “40/12” denotes a conversion factor for converting the carbon content in a structure of polydimethylsiloxane (PDMS) to the total amount of PDMS.

The structural formula of polydimethylsiloxane is illustrated below.

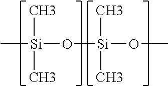

The external additive may be used in combination of one or more types of minute external additives such as known inorganic particles which have not surface-treated and known inorganic particles which have been surface-treated with a hydrophobizing agent other than silicone oils.

Examples of the hydrophobizing agent include silane coupling agents, silylation agents, silane coupling agents containing fluorinated alkyl groups, organotitanate coupling agents, and aluminium coupling agents.

Examples of a material of the inorganic particles include silica, alumina, titanium oxide, barium titanate, magnesium titanate, calcium titanate, strontium titanate, zinc oxide, tin oxide, silica sand, clay, mica, wollastonite, diatom earth, chromium oxide, cerium oxide, red iron oxide, antimony trioxide, magnesium oxide, zirconium oxide, barium sulfate, calcium carbonate, barium carbonate, silicon carbide and silicon nitride.

Inorganic particles having a smaller average particle diameter than an average particle diameter of silicone-oil-treated inorganic particles are suitably used in combination.

Small inorganic particles as described above increase a coverage rate on a surface of the toner. Thus, a developer can have appropriate flowability, so that, during developing, a latent image can be faithfully reproduced and a developing amount can be ensured. Additionally, the toner can be prevented from aggregating or solidifying during storage of the developer.

The external additives is preferably contained in the toner in a range of from 0.01% by mass through 5% by mass, more preferably in a range of from 0.1% by mass through 2% by mass.

### <Other Components>

Examples of the other components include colorants, cleaning aids, and resin particles.

### <<Colorant>>

Examples of the colorant include carbon black, nigrosine dye, iron black, Naphthol Yellow S, Hansa Yellow (10G, 5G and G), cadmium yellow, yellow iron oxide, yellow ocher, yellow lead, titanium yellow, polyazo yellow, oil yellow, Hansa Yellow (GR, A, RN and R), pigment yellow L, benzidine yellow (G and GR), permanent yellow (NCG), Vulcan Fast Yellow (5G and R), tartrazine lake, quinoline yellow lake, Anthrasan yellow BGL, isoindolinone yellow, red iron oxide, red lead, lead vermilion, cadmium red, cadmium mercury red, antimony vermilion, permanent red 4R, parared, fiser red, parachloroorthonitro aniline red, Lithol Fast Scarlet G, brilliant fast scarlet, Brilliant Carmine BS, permanent red (F2R, F4R, FRL, FRLL and F4RH), Fast Scarlet VD, Vulcan Fast Rubin B, Brilliant Scarlet G, Lithol Rubin GX, permanent red F5R, Brilliant Carmin 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, Rhodamine Lake B, Rhodamine Lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methylviolet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and mixtures thereof.

An amount of the colorant is not particularly limited and may be appropriately selected depending on the intended purpose, but is preferably in a range of from 1% by mass through 15% by mass, more preferably in a range of from 3% by mass through 10% by mass relative to the mass of the toner.

### <<Cleanability Improving Agent>>

A cleanability improving agent may be used in combination with the toner for the purpose of removing the developer remaining after transfer on the latent image bearer or a primary transfer medium.

Examples of the cleanability improving agent include metal salts of fatty acids (e.g., zinc stearate, calcium stearate, and stearic acid) and polymer particles made through, for example, soap-free emulsion polymerization (e.g., polymethyl methacrylate particles and polystyrene particles).

The polymer particles preferably have a relatively narrow particle size distribution and the volume average particle diameter in a range of from 0.01 μm through 1 μm.

### <Average Circularity>

Average circularity of the toner is not particularly limited and may be appropriately selected depending on the intended purpose, but is preferably in a range of from 0.98 through 1.00 from the viewpoint of achieving an image of good quality.

An optical sensing method is appropriately used for measuring shape of the toner. In the optical sensing method, a suspension liquid containing particles is allowed to pass through a plate-like sensing band in an imaging portion, during which images of the particles are optically sensed and analyzed by a CCD camera.

A circumferential length of a circle having an area equal to a projected area of the particle is divided by a circumferential length of an actual particle, which is determined as the average circularity.

Thus-determined value of the average circularity refers to a value measured as the average circularity using a flow-type particle image analyzer FPIA-3000.

Specifically, from 0.1 mL through 0.5 mL of a surfactant (preferably alkylbenzene sulfonate) serving as a dispersant is added to from 100 mL through 150 mL of water, from which solid impurities have previously been removed, in a container. Then, from about 0.1 g through about 0.5 g of a measurement sample is added to the container and dispersed to obtain a suspension liquid.

The suspension liquid is dispersed with an ultrasonic disperser for from about 1 min through about 3 min. A shape and a distribution of the toner are measured using the analyzer at a concentration of the resultant dispersion liquid of from 3,000 particles per microliter through 10,000 particles per microliter.

### <Method for Producing Toner>

The toner is preferably produced by a method for producing a toner, the method including a liquid droplet forming step and a liquid droplet solidifying step, from the viewpoint of providing an inexpensive electrophotographic toner which results in an image of good quality.

The liquid droplet forming step is not particularly limited and may be appropriately selected depending on the intended purpose, so long as a mixed liquid in which a composition containing the binder resin and the release agent is dissolved or dispersed in an organic solvent is discharged to form liquid droplets.

The liquid droplet solidifying step is not particularly limited and may be appropriately selected depending on the intended purpose, so long as the liquid droplets are solidified to form particles.

The method for producing a toner will now be described along with a toner producing apparatus using for the method referring to FIGS. 11 to 17.

The toner producing apparatus includes a liquid droplet discharging means and a liquid droplet solidifying/collecting means.

### <<Liquid Droplet Discharging Means>>

The liquid droplet discharging means not particularly limited and may be appropriately selected depending on the intended purpose, so long as the liquid droplet discharging means is configured to narrow a particle diameter distribution of discharged liquid droplets. Examples of the liquid droplet discharging means include one fluid nozzle, two fluid nozzles, a membrane vibration discharging means, a Rayleigh breakup discharging means, a liquid vibration discharging means, and a liquid column resonance discharging means. Example of the membrane vibration discharging means includes those described in Japanese Unexamined Patent Application Publication No. 2008-292976. Example of the Rayleigh breakup discharging means includes those described in Japanese Patent No. 4647506. Example of the liquid vibration discharging means includes those described in Japanese Unexamined Patent Application Publication No. 2010-102195.

In order to narrow the particle diameter distribution of the liquid droplets and ensure productivity of the toner, a liquid droplet forming liquid column resonance is preferably utilized. In the liquid droplet forming liquid column resonance, a liquid contained in a liquid column resonance liquid chamber, which has a plurality of discharge holes, is vibrated to form a standing wave based on liquid column resonance, and then the liquid is discharged from a hole formed in a region corresponding to an anti-node of the standing wave.

### —Liquid Column Resonance Liquid Droplet Discharging Means (Liquid Column Resonance Discharging Means)—

A liquid column resonance liquid droplet discharging means configured to discharge liquid droplets utilizing liquid column resonance will now be described.

FIG. 11 illustrates a liquid column resonance liquid droplet discharging means 11. The liquid column resonance liquid droplet discharging means 11 includes a common liquid supplying path 17 and a liquid column resonance liquid chamber 18. The liquid column resonance liquid chamber 18 communicates with the common liquid supplying path 17 which is disposed on one of wall surfaces at both ends in a longitudinal direction. The liquid column resonance liquid chamber 18 includes discharge holes 19 and a vibration generating means 20. The discharge holes are disposed to one of wall surfaces coupled to the wall surfaces at the both ends and are configured to discharge liquid droplets 21. The vibration generating means is disposed on a wall surface opposite to the wall surface in which the discharge holes 19 are formed and is configured to generate high frequency vibration in order to form a liquid column resonance standing wave. Notably, the vibration generating means 20 is coupled to a high frequency power source (not illustrated).

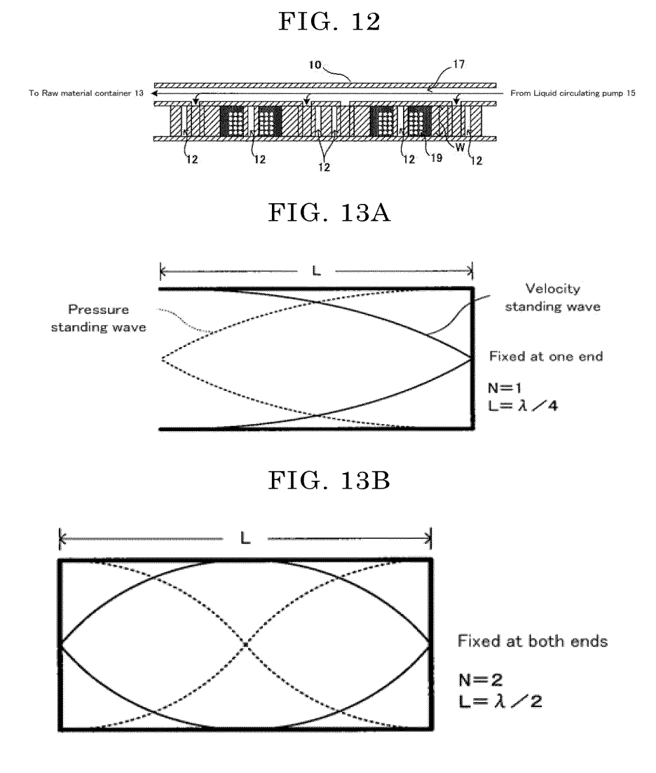

The liquid to be discharged by the liquid column resonance liquid droplet discharging means 11 may be a “particle component-containing liquid” in which a component of particles to be formed is dissolved or dispersed in a solvent. Alternatively, when the component is in a liquid state under a discharging condition, the liquid may be a “particle component melted liquid” in which the component of particles are melted without necessarily containing the solvent. Hereinafter, the particle component-containing liquid and the particle component melted liquid will be collectively referred to as a “toner component liquid” when describing production of the toner. A toner component liquid 14 flows through a liquid supplying pipe into the common liquid supplying path 17 of a liquid column resonance liquid droplet forming unit 10 illustrated in FIG. 12 by the action of liquid circulating pump (not illustrated), and is supplied into the liquid column resonance liquid chamber 18 of the liquid column resonance liquid droplet discharging means 11 illustrated in FIG. 11. In the liquid column resonance liquid chamber 18 filled with the toner component liquid 14, a pressure distribution is formed by a liquid column resonance standing wave generated by the vibration generating means 20. Then, the liquid droplets 21 are discharged from the discharge holes 19 which are disposed in the region corresponding to the anti-node of the liquid column resonance standing wave, the anti-node having high amplitude and large pressure fluctuation. The anti-node of the liquid column standing wave means a region other than a node of the standing wave. The anti-node is preferably a region in which the pressure fluctuation of the standing wave has high amplitude enough to discharge the liquid, and more preferably a region having a width corresponding to ¼ of wavelength each from a position of a local maximum amplitude of a pressure standing wave (i.e., a node of a velocity standing wave) in directions toward positions of a local minimum amplitude. Even when a plurality of discharge holes are opened, liquid droplets can be formed approximately uniformly from the discharge holes so long as the discharge holes are formed in the anti-node of the standing wave. Additionally, the liquid droplets can be discharged efficiently, and the discharge holes are less likely to be clogged. Notably, the toner component liquid 14 which has flowed through the common liquid supplying path 17 is returned to a raw material container via a liquid returning pipe (not illustrated). When the liquid droplets 21 are discharged to decrease an amount of the toner component liquid 14 in the liquid column resonance liquid chamber 18, a flow rate of the toner component liquid 14 supplied from the common liquid supplying path 17 is increased by the action of suction power resulting from the liquid column resonance standing wave in the liquid column resonance liquid chamber 18. As a result, the liquid column resonance liquid chamber 18 is refilled with the toner component liquid 14. When the liquid column resonance liquid chamber 18 is refilled with the toner component liquid 14, a flow rate of the toner component liquid 14 flowing through the common liquid supplying path 17 returns to as before.

The liquid column resonance liquid chamber 18 of the liquid column resonance liquid droplet discharging means 11 is formed by joining together frames. The frame is made of a material having stiffness high but uninfluential to a liquid resonance frequency at a driving frequency (e.g., a metal, a ceramic, and silicon). As illustrated in FIG. 11, a length L between the wall surfaces at both ends of the liquid column resonance liquid chamber 18 in the longitudinal direction is determined based on the principle of the liquid column resonance described below. A width W of the liquid column resonance liquid chamber 18 illustrated in FIG. 12 is desirably shorter than ½ of the length L of the liquid column resonance liquid chamber 18 so as not to add any frequency unnecessary for the liquid column resonance. One liquid column resonance liquid droplet discharging unit 10 preferably includes a plurality of liquid column resonance liquid chambers 18 in order to improve productivity drastically. The number of the liquid column resonance liquid chambers is not limited, but one liquid droplet forming unit most preferably includes from 100 through 2,000 liquid column resonance liquid chambers 18 because operability and productivity can both be satisfied. The common liquid supplying path 17 is coupled to and communicated with the liquid column resonance liquid chambers 18 via liquid supplying flow paths corresponding to each chamber.

The vibration generating means 20 of the liquid column resonance liquid droplet discharging means 11 is not particularly limited, so long as the vibration generating means can be driven at a predetermined frequency. However, the vibration generating means is desirably formed by attaching a piezoelectric material onto an elastic plate 9. The elastic plate constitutes a portion of the wall of the liquid column resonance liquid chamber so as not to contact the piezoelectric material with the liquid. The piezoelectric material may be, for example, piezoelectric ceramics such as lead zirconate titanate (PZT), and is often laminated due to small displacement amount. Other examples of the piezoelectric material include piezoelectric polymers (e.g., polyvinylidene fluoride (PVDF)) and monocrystals (e.g., crystal, LiNbO₃, LiTaO₃, and KNbO₃). The vibration generating means is desirably disposed so as to be controlled individually in every liquid column resonance liquid chamber 18. The vibration generating means is desirably a block-shaped vibration member which is made of one of the above materials and partially cut according to geometry of the liquid column resonance liquid chamber, so that the liquid column resonance liquid chambers can be controlled individually via the elastic plates.

A diameter (Dp) of an opening of the discharge hole 19 is preferably in a range of from 1 [μm] through 40 [μm]. When the diameter (Dp) is less than 1 [μm], very small liquid droplets are formed, so that the toner is not obtained in some cases. Additionally, when solid particles (e.g., pigment) are contained as a component of the toner, the discharge holes 19 may often be clogged to deteriorate the productivity. When the diameter (Dp) is greater than 40 [μm], liquid droplet having larger diameters are formed. Therefore, when the liquid droplet having larger diameters are dried and solidified to achieve a desired toner particle diameter in a range of from 3 μm through 6 μm, a toner composition is required to dilute with an organic solvent to a very thin liquid, so that a lot of drying energy is disadvantageously needed for obtaining a predetermined amount of toner. As can be seen from FIG. 12, the discharge holes 19 are preferably disposed in a width directions of the liquid column resonance liquid chamber 18 because many discharge holes 19 can be disposed, leading to improved production efficiency. Additionally, a liquid column resonance frequency is desirably determined appropriately after confirming how the liquid droplet are discharged because the liquid column resonance frequency varies depending on arrangement of the discharge holes 19.

A cross-sectional shape of the discharge hole 19 is illustrated in, for example, FIG. 11 as a tapered shape with the diameter of the opening gradually decreasing. However, the cross-sectional shape may be appropriately selected.

A mechanism by which the liquid droplet forming unit forms liquid droplets utilizing the liquid column resonance will now be described.

Firstly, the principle of the liquid column resonance that occurs in the liquid column resonance liquid chamber 18 of the liquid column resonance liquid droplet discharging means 11 illustrated in FIG. 11 will now be described. The following relationship is satisfied:

λ=c/f (Expression 1)

where
λ denotes a wavelength at which liquid resonance occurs;
c denotes sound velocity of the toner component liquid in the liquid column resonance liquid chamber; and
f denotes a driving frequency applied by the vibration generating means 20 to the toner component liquid serving as a medium.

Assuming that, in the liquid column resonance liquid chamber 18 of FIG. 11, a length from a frame end at a fixed end side to an frame end at a common liquid supplying path 17 side is L, a height h1 (=about 80 [μm]) of the frame end at the common liquid supplying path 17 side is about 2 times as high as a height h2 (=about 40 [μm]) of a communication port, and the frame end at the common liquid supplying path side is equivalent to a closed fixed end, that is, both ends are considered to be fixed; resonance is most efficiently formed when the length L corresponds to an even multiple of ¼ of a wavelength λ. Thai is, the following Expression 2 is satisfied:

L=(N/4)λ (Expression 2)

(where N is an even number.).

The Expression 2 is also satisfied when the both ends are free, that is, the both ends are completely opened.

Likewise, when one end is equivalent to a free end from which pressure is released, and the other end is closed (fixed end), that is, when one of the ends is fixed or one of the ends is free, resonance is most efficiently formed when the length L corresponds to an odd multiple of ¼ of the wavelength λ. That is, N in the Expression 2 is an odd number.

The most efficient driving frequency f is calculated from the Expressions 1 and 2 as follows:

f=N×c/(4L) (Expression 3).

However, actually, the vibration is not amplified unlimitedly, because the liquid has viscosity which attenuates the resonance. Therefore, the resonance has a Q factor, and also occurs at a frequency adjacent to the most efficient driving frequency f calculated by the Expression 3, as represented by Expressions 4 and 5 described below.

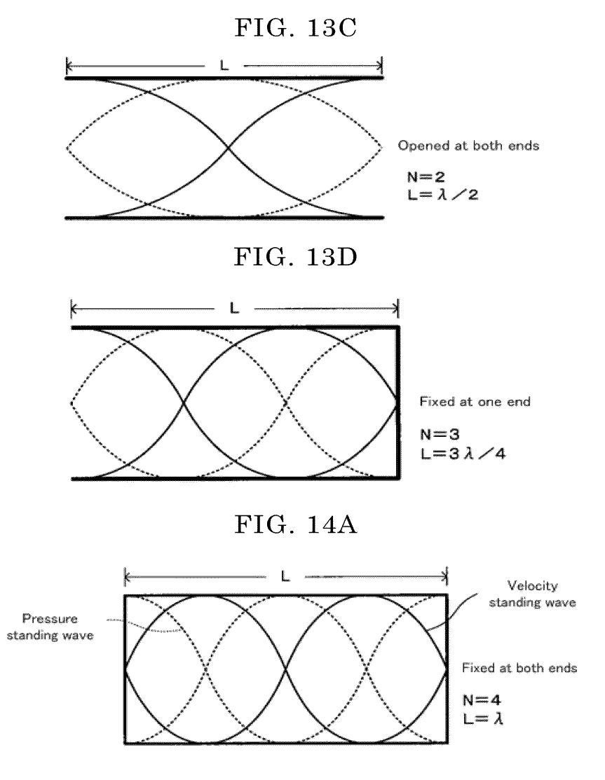

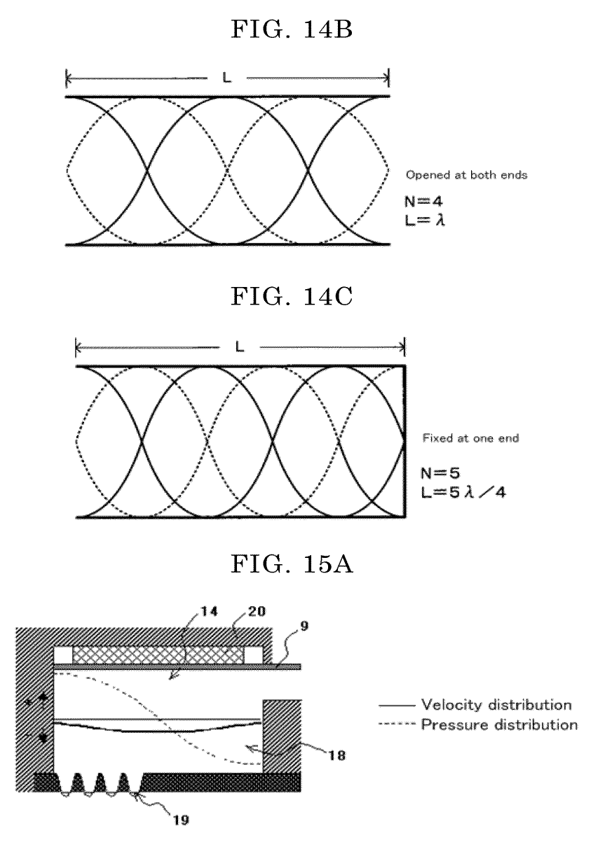

FIGS. 13A to 13D illustrate shapes of standing waves of velocity and pressure fluctuations (resonance mode) when N=1, 2, and 3. FIGS. 14A to 14C illustrate shapes of standing waves of velocity and pressure fluctuations (resonance mode) when N=4 and 5. A standing wave is actually a compressional wave (longitudinal wave), but is commonly expressed as in FIGS. 13A to 13D and 14A to 14C. A solid line represents a velocity standing wave and a dotted line represents a pressure standing wave. For example, as can be seen from FIG. 13A illustrating a case where a one end is fixed and N=1, an amplitude of a velocity distribution is zero at a closed end and the maximum at a free end, which is understandable intuitively. Assuming that a length between both ends of the liquid column resonance liquid chamber in the longitudinal direction is L and a wavelength at which liquid column resonance occurs is λ; the standing wave most efficiently occurs when the integer N is in a range of from 1 through 5. Standing wave patterns vary depending on whether each end is opened or closed. Therefore, standing wave patterns in various opening/closing conditions are also described in the drawings. As described below, the conditions of the ends are determined depending on states of openings of the discharge holes and states of openings on a supply side. Notably, in the acoustics, a free end refers to an end at which moving velocity of a medium (liquid) is zero in the longitudinal direction, but pressure reaches the local maximum to the contrary. Conversely, a closed end refers to an end at which the moving velocity of the medium is zero. The closed end is considered as an acoustically hard wall and reflects a wave. When an end is ideally perfectly closed or opened, resonance standing waves as illustrated in FIGS. 13A to 13D and 14A to 14C are formed by superposition of waves. The standing wave patterns vary depending also on the number of the discharge holes and positions at which the discharge holes are opened, and hence a resonance frequency appears in a position shifted from a position determined from the Expression 3. However, stable discharging conditions can be created by appropriately adjusting the driving frequency. For example, assuming that sound velocity c of the liquid is 1,200 [m/s], a length L of the liquid column resonance liquid chamber is 1.85 [mm], and a resonance mode in which both ends are completely equivalent to fixed ends due to the presence of walls on the both ends and N=2 is used; the most efficient resonance frequency is calculated as 324 kHz from the Expression 2. In another example, assuming that the sound velocity c of the liquid is 1,200 [m/s] and the length L of the liquid column resonance liquid chamber is 1.85 [mm], these conditions are the same as above, and a resonance mode in which both ends are equivalent to fixed ends due to the presence of walls on the both ends and N=4 is used; the most efficient resonance frequency is calculated as 648 kHz from the Expression 2. Thus, a higher-order resonance can also be utilized even in a single liquid column resonance liquid chamber.

In order to increase the frequency, the liquid column resonance liquid chamber of the liquid column resonance liquid droplet discharging means 11 illustrated in FIG. 11 preferably has both ends which are equivalent to a closed end or can be considered as an acoustically soft wall due to influence from the openings of the discharge holes, but is not limited thereto. The both ends may be free. The influence from the openings of the discharge holes means decreased acoustic impedance and, in particular, increased compliance component. Therefore, the arrangement in which walls are formed at both ends of the liquid column resonance liquid chamber in the longitudinal direction, as illustrated in FIGS. 13A and 14A, is preferable because all resonance modes including a mode in which both ends are fixed and a mode in which one of ends is free and a discharge hole side is considered to be opened can be used.

The number of openings of the discharge holes, positions at which the openings are disposed, and cross-sectional shapes of the discharge holes are also factors which determine the driving frequency. The driving frequency can be appropriately determined based on these factors.

For example, when the number of the discharge holes is increased, the liquid column resonance liquid chamber gradually becomes free at an end which has been fixed, so that a resonance standing wave which is approximately the same as a standing wave at an opened end occurs and the driving frequency becomes high. Further, the end which has been fixed becomes free starting from a position at which an opening of the discharge hole that is the most adjacent to the liquid supplying path is disposed. As a result, the cross-sectional shape of the discharge hole is changed to a round shape, or a volume of the discharge hole is varied depending on a thickness of the frame, so that an actual standing wave has a shorter wavelength and a higher frequency than the driving frequency. When a voltage is applied to the vibration generating means at the driving frequency determined as described above, the vibration generating means deforms and the resonance standing wave most efficiently occurs at the driving frequency. The liquid column resonance standing wave also occurs at a frequency adjacent to the driving frequency at which the resonance standing wave most efficiently occurs. That is, assuming that a length between both ends of the liquid column resonance liquid chamber in the longitudinal direction is L and a distance to a discharge hole that is the most adjacent to an end at a liquid supplying side is Le; a driving waveform having as a main component the driving frequency f, which is in a range determined by following Expressions 4 and 5 using both of the lengths L and Le, can be used to vibrate the vibration generating means and induce the liquid column resonance to discharge the liquid droplets from the discharge holes.

N×c/(4L)≦f≦N×c/(4Le) (Expression 4)

N×c/(4L)≦f≦(N+1)×c/(4Le) (Expression 5)

Notably, a ratio of the length L between both ends of the liquid column resonance liquid chamber in the longitudinal direction to the distance Le to the discharge hole that is the most adjacent to the end at the liquid supplying side preferably satisfies: Le/L>0.6.

Based on the principle of the liquid column resonance phenomenon described above, a liquid column resonance pressure standing wave is formed in the liquid column resonance liquid chamber 18 illustrated in FIG. 11, and the liquid droplet are continuously discharged from the discharge holes 19 disposed in a portion of the liquid column resonance liquid chamber 18. Notably, the discharge holes 19 are preferably disposed at positions at which the pressure of the standing wave vary to the greatest extent from the viewpoints of high discharging efficiency and driving at a lower voltage. One liquid column resonance liquid chamber 18 may include one discharge hole 19, but preferably includes a plurality of discharge holes from the viewpoint of productivity. Specifically, the number of discharge holes is preferably in a range of from 2 through 100. When more than 100 discharge holes are disposed, it is necessary for the voltage to be applied to the vibration generating means 20 to set to a high level in order to discharge desired liquid droplets from 100 discharge holes 19, which causes the piezoelectric material serving as the vibration generating means 20 to behave unstably. When the plurality of discharge holes 19 are opened, a pitch between the discharge holes is preferably 20 [μm] or longer but equal to or shorter than the length of the liquid column resonance liquid chamber. When the pitch between the discharge holes is less than 20 [μm], there is a high possibility that liquid droplets, which are discharged from discharge holes adjacent to each other, collide with each other to form a larger droplet, leading to deterioration of toner particle diameter distribution.

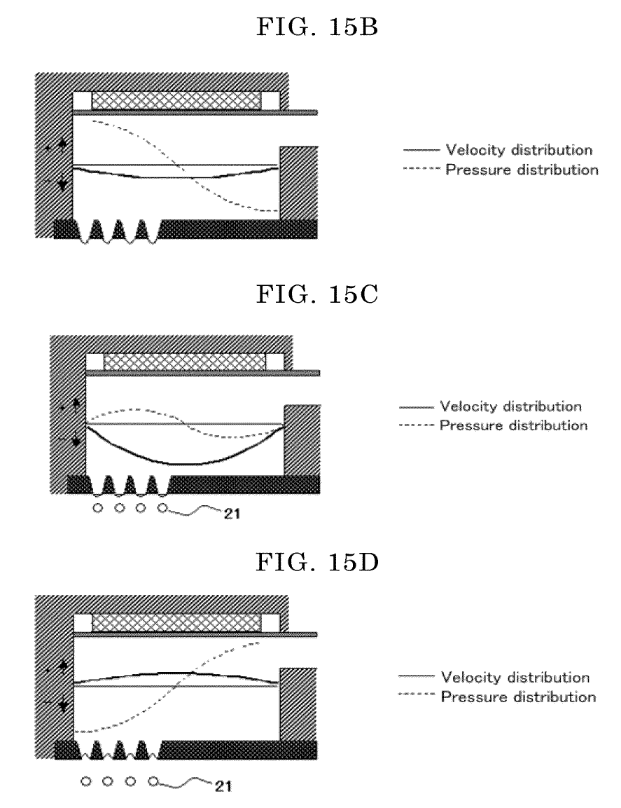

A liquid column resonance phenomenon which occurs in the liquid column resonance liquid chamber of a liquid droplet discharging head of the liquid droplet forming unit will now be described referring to FIGS. 15A to 15E. Notably, in these drawings, a solid line drawn in the liquid column resonance liquid chamber represents a velocity distribution plotting velocity at arbitrary measuring positions between ends at the fixed end side and at the common liquid supplying path side within the liquid column resonance liquid chamber. A direction from the common liquid supplying path to the liquid column resonance liquid chamber is assumed as plus and the opposite direction is assumed as minus. A dotted line drawn in the liquid column resonance liquid chamber represents a pressure distribution plotting pressure at arbitrary measuring positions between ends at the fixed end side and at the common liquid supplying path side within the liquid column resonance liquid chamber. A positive pressure relative to atmospheric pressure is assumed as plus and a negative pressure is assumed as minus. In the case of the positive pressure, pressure is applied in a downward direction in the drawings. In the case of negative pressure, pressure is applied in an upward direction in the drawings. In the drawings, the common liquid supplying path is opened as described above and the height of the frame serving as the fixed end (height h1 in FIG. 11) is about 2 times or more as high as the height of an opening at which the common liquid supplying path 17 is communicated with the liquid column resonance liquid chamber 18 (height h2 in FIG. 11). Therefore, the drawings represent temporal changes of the velocity distribution and the pressure distribution under an approximate condition in which both ends of the liquid column resonance liquid chamber 18 are approximately fixed ends.

FIG. 15A illustrates a pressure waveform and a velocity waveform in the liquid column resonance liquid chamber 18 at the time when the liquid droplets are discharged. In FIG. 15B, meniscus pressure is increased again after the liquid droplets are discharged and then the liquid is supplied immediately. As illustrated in these drawings, pressure in a flow path, on which the discharge holes 19 are disposed, in the liquid column resonance liquid chamber 18 is the local maximum. Then, as illustrated in FIG. 15C, positive pressure adjacent to the discharge holes 19 is decreased and shifted to a negative pressure side. Thus, the liquid droplets 21 are discharged.

Then, as illustrated in FIG. 15D, the pressure adjacent to the discharge holes 19 is the local minimum. From this time point, the liquid column resonance liquid chamber 18 starts to be filled with the toner component liquid 14. Then, as illustrated in FIG. 15E, negative pressure adjacent to the discharge holes 19 is decreased and shifted to a positive pressure side. At this time point, the liquid chamber is completely filled with the toner component liquid 14. Then, as illustrated in FIG. 15A, positive pressure in a liquid droplet discharging region of the liquid column resonance liquid chamber 18 is the local maximum again to discharge the liquid droplets 21 from the discharge holes 19. Thus, the liquid column resonance standing wave occurs in the liquid column resonance liquid chamber by the vibration generating means driven at a high frequency. The discharge holes 19 are disposed in the liquid droplet discharging region corresponding to the anti-node of the liquid column resonance standing wave at which pressure vary to the greatest extent. Therefore, the liquid droplets 21 are continuously discharged from the discharge holes 19 synchronously with a cycle of the anti-node.

### <<Liquid Droplet Solidifying Step>>

The toner according to the present invention can be obtained by solidifying and then collecting the liquid droplets of the toner component liquid discharged into a gas from the above-described liquid droplet discharging means.

### <<Liquid Droplet Solidifying Means>>

Although depending on properties of the toner component liquid, a method for solidifying the liquid droplets is not limited basically so long as the toner component liquid can be turned into a solid state.

For example, when the toner component liquid is a solution or dispersion liquid in which solid raw materials are dissolved or dispersed in a volatile solvent, the liquid droplets can be solidified by jetting liquid droplets and then drying the liquid droplets in a conveying gas stream, that is, volatilizing the solvent. As for drying of the solvent, the degree of drying can be adjusted by appropriately selecting, for example, a temperature and vapor pressure of a gas to be jetted, and the type of the gas. The solvent may be incompletely evaporated off, so long as collected particles are kept in a solid state. In this case, the collected particles may be additionally dried in a separate step. The liquid droplets may be solidified by other methods such as changing a temperature or undergoing a chemical reaction.

### <<Solidified Particle Collecting Means>>

Solidified particles can be collected from the gas by known powder collecting means such as a cyclone collector and a back filter.

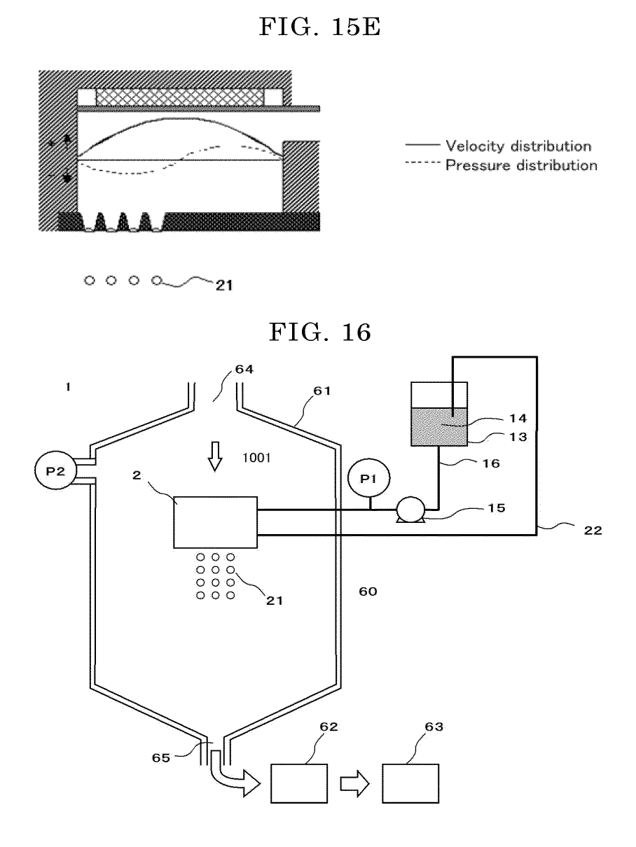

FIG. 16 is a cross-sectional diagram illustrating one exemplary toner producing apparatus configured to perform the method for producing a toner according to the present invention. A toner producing apparatus 1 mainly includes a liquid droplet discharging means 2 and a drying/collecting unit 60.

The liquid droplet discharging means 2 is coupled to a raw material container 13 and a liquid circulating pump 15, and is configured to supply the toner component liquid 14 to the liquid droplet discharging means 2 at any time. The raw material container is configured to contain the toner component liquid 14. The liquid circulating pump is configured to supply the toner component liquid 14 contained in the raw material container 13 into the liquid droplet discharging means 2 through a liquid supplying pipe 16 and to apply pressure to pump the toner component liquid 14 in the liquid supplying pipe 16 back to the raw material container 13 through a liquid returning pipe 22. The liquid supplying pipe 16 includes a pressure gauge P1 configured to measure pressure of liquid, and the drying/collecting unit 60 includes a pressure gauge P2 configured to measure pressure inside a chamber. Pressure at which the liquid is fed into the liquid droplet discharging means 2 is managed by the pressure gauge P1, and pressure inside the drying/collecting unit 60 is managed by the pressure gauge P2. When P1>P2, the toner component liquid 14 may disadvantageously leak from the discharge holes 19. When P1<P2, a gas may disadvantageously enter the discharging means, causing the liquid droplets not to be discharged. Therefore, it is preferable that P1≈P2.

A conveying gas stream 1001 from a conveying gas stream inlet port 64 is formed within a chamber 61. The liquid droplets 21 discharged from the liquid droplet discharging means 2 are conveyed downward not only by gravity but also by the conveying gas stream 1001, and then collected by a solidified particle collecting means 62.

Notably, in FIG. 16, reference numeral 65 denotes a conveying gas stream outlet port, and reference numeral 63 denotes a solidified particle storing portion.

When jetted liquid droplets are brought into contact with each other prior to drying, the jetted liquid droplets are aggregated into one particle (hereinafter, this phenomenon is referred to as coalescence). In order to obtain solidified particles having a uniform particle diameter distribution, it is necessary to keep the jetted liquid droplets apart from each other. However, although the liquid droplets are jetted at a certain initial velocity, but gradually slowed down due to air resistance. Therefore, the subsequent liquid droplets catch up with and coalesce with the preceding liquid droplets having been slowed down. This phenomenon occurs constantly. When thus-coalesced particles are collected, the coalesced particles have a very poor particle diameter distribution. In order to prevent the liquid droplets from coalescing with each other, the liquid droplets are needed to be solidified and conveyed simultaneously, while preventing, by the action of the conveying gas stream 1001, the liquid droplets from slowing down and from contacting with each other. Eventually, thus-solidified particles are conveyed to the solidified particle collecting means.

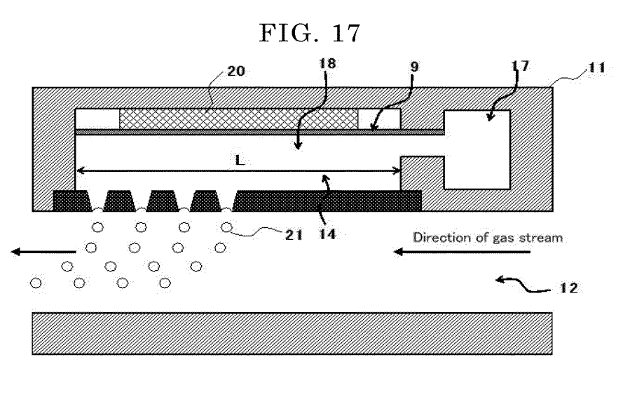

For example, as illustrated in FIG. 11, when a portion of the conveying gas stream 1001 is orientated, as a first air stream, in the same direction as a liquid droplet discharging direction by disposing a gas stream path 12 adjacent to the liquid droplet discharging means, the liquid droplets can be prevented from slowing down immediately after the liquid droplets are discharged to prevent the liquid droplets from coalescing with each other. Alternatively, the air stream may be orientated in a transverse direction to the liquid droplet discharging direction, as illustrated in FIG. 17. Alternatively, although not illustrated, the air stream may be oriented at an angle, the angle being desirably determined so as to discharge the liquid droplets in a direction away from the liquid droplet discharging means. When a coalescing preventing air stream is orientated in the transverse direction to the liquid droplet discharging direction as illustrated in FIG. 17, the coalescing preventing air stream is preferably orientated in a direction in which trajectories of the liquid droplets do not overlap with each other when the liquid droplets are conveyed from the discharging holes by the coalescing preventing air stream.

After coalescing is prevented with the first air stream as described above, the solidified particles may be conveyed to the solidified particle collecting means 62 with a second air stream.

A velocity of the first air stream is desirably equal to or higher than a velocity at which the liquid droplets are jetted. When a velocity of the coalescing preventing air stream is lower than the velocity at which the liquid droplets are jetted, the coalescing preventing air stream is difficult to exert a function of preventing the liquid droplet particles from contacting with each other, the function being the essential purpose of the coalescing preventing air stream.

The first air stream may have an additional property so as to prevent the liquid droplets from coalescing, and may not be necessarily the same as the second air stream. A chemical substance which promotes solidification of surfaces of the particles may be mixed in the coalescing preventing air stream, or may be imparted to the air stream so as to exert a physical effect.

The conveying gas stream 1001 is not particularly limited in terms of a type of air stream, and may be a laminar flow, a swirl flow, or a turbulent flow. A kind of a gas constituting the conveying gas stream 1001 is not particularly limited, and may be air or an incombustible gas (e.g., nitrogen). A temperature of the conveying gas stream 1001 may be adjusted appropriately, and is desirably constant during production. The chamber 61 may include a means configured to change the type of the conveying gas stream 1001. The conveying gas stream 1001 may be used not only for preventing the liquid droplets 21 from coalescing with each other but also for preventing the liquid droplets from depositing on the chamber 61.

A velocity of the conveying gas stream is preferably in a range of from 2.0 m/s through 8.0 m/s, more preferably in a range of from 6.0 m/s through 8.0 m/s. When the velocity of the conveying gas stream is less than 2.0 m/s, a third or more peak may appear in the volume basis particle size distribution of the toner. When the velocity of the conveying gas stream is more than 8.0 m/s, the second peak disappears in the volume basis particle size distribution of the toner, potentially leading to deteriorated cleanability. Controlling the conveying gas stream can produce the toner having the second peak particle diameter in a range of from 1.21 times through 1.31 times as large as the most frequent diameter in the volume basis particle size distribution.

When toner particles collected by the solidified particle collecting means 62 illustrated in FIG. 16 contain a large amount of a residual solvent, a second drying is performed in order to reduce the residual solvent, if necessary. The second drying may be performed using commonly known drying means such as fluid bed drying and vacuum drying. An organic solvent remaining in the toner not only change properties of the toner (e.g., heat resistant storability, fixability, and chargeability) over time, but also increases a possibility that users and peripheral devices are adversely affected by the organic solvent volatilized during heat-fixing. Therefore, the toner particles is sufficiently dried.

### <<External Addition Treatment>>

Specific examples of a means for externally adding a silicone-oil-treated external additive or other external additives to the resultant dried toner powder include a method in which impact is applied to a mixture using a high-speed rotating blade; and a method in which a mixture is caused to pass through a high-speed air stream for acceleration to allow particles or aggregates contained in the mixture to collide with each other or with an appropriate collision plate.

Examples of a device used for external addition include ONGMILL (product of Hosokawa Micron Corp.), a modified I-type mill (product of Nippon Neumatic Co., Ltd.) so as to reduce pulverizing air pressure, HYBRIDIZATION SYSTEM (product of Nara Machinery Co., Ltd.), CRYPTRON SYSTEM (production of Kawasaki Heavy Industries, Ltd.) and an automatic mortar.

### (Image Forming Apparatus, Image Forming Method, and Process Cartridge)

### <Image Forming Apparatus and Process Cartridge>

An image forming apparatus according to the present invention is configured to form an image using the toner according to the present invention.

Notably, the toner according to the present invention can be used for either a one-component developer or a two-component developer, but is preferably used as the one-component developer.

An image forming apparatus according to the present invention preferably includes an endless intermediate transfer means.

The image forming apparatus according to the present invention preferably includes a latent image bearer, and a cleaning means configured to clean a toner remaining on at least one of the latent image bearer and the intermediate transfer means.

The cleaning means may or may not include a cleaning blade.

The image forming apparatus preferably includes a primary transfer means, a toner removing means, a secondary transfer means, and a toner removing means for an intermediate transfer member. The primary transfer means is configured to transfer a visible image formed on a surface of the latent image bearer with a toner onto the intermediate transfer member. The toner removing means is configured to remove a toner remaining on the surface of the latent image bearer with a cleaning blade for a latent image bearer, after transferring. The secondary transfer means is configured to transfer the visible image from the intermediate transfer member to a transferred medium. The toner removing means for an intermediate transfer member is configured to remove a toner remaining on the intermediate transfer member with a cleaning blade for an intermediate transfer member, after transferring.

The cleaning blade for a latent image bearer preferably has rebound resilience in a range of from 10% through 35%.

The cleaning blade for a latent image bearer preferably is brought into contact with the latent image bearer at pressure in a range of from 20 N/m through 50 N/m.

A contact angle θ is preferably in a range of from 70° through 82°, the contact angle θ being formed between an end surface of the cleaning blade for a latent image bearer and a tangential line extended from a point at which the cleaning blade for a latent image bearer is brought into contact with the surface of the latent image bearer.

The cleaning blade for an intermediate transfer member preferably has rebound resilience in a range of from 35% through 55%.

The cleaning blade for an intermediate transfer member preferably is brought into contact with the intermediate transfer member at pressure in a range of from 20 N/m through 50 N/m.

A contact angle θ is preferably in a range of from 70° through 82°, the contact angle θ being formed between an end surface of the cleaning blade for an intermediate transfer member and a tangential line extended from a point at which the cleaning blade for an intermediate transfer member is brought into contact with the surface of the intermediate transfer member.

The image forming apparatus according to the present invention preferably includes a fixing means configured to fix an image using a roller including a heating device or a belt including a heating device.

The image forming apparatus according to the present invention preferably includes a fixing means without needing to apply oil to a fixing member.

The image forming apparatus according to the present invention preferably includes appropriately selected other means, e.g., a charge eliminating means, a recycling means, and a controlling means, if necessary.

The image forming apparatus according to the present invention may include a process cartridge including, for example, a latent image bearer, a developing means, and a cleaning means. The process cartridge may be detachably mounted in a main body of the image forming apparatus.

Alternatively, at least one selected from the group consisting of a charging means, an exposure means, a developing means, a transfer means, a separating means, and a cleaning means may be supported together with the latent image bearer to form a process cartridge. The process cartridge may be a single unit detachably mounted in the main body of the image forming apparatus using a guiding means such as a rail disposed in the main body of the image forming apparatus.

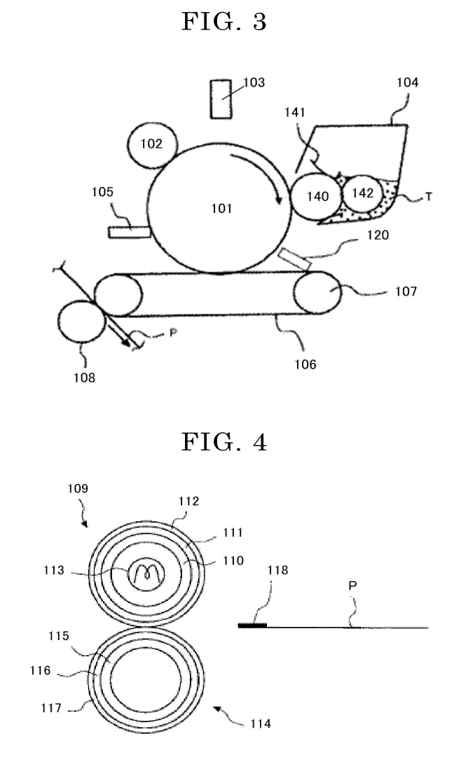

FIG. 3 is a diagram illustrating one exemplary image forming apparatus according to the present invention.

The image forming apparatus includes, in a main body casing (not illustrated), a latent image bearer 101 configured to be rotary driven clockwise in FIG. 3. The image forming apparatus further includes, for example, a charging device 102, an exposure device 103, a developing device 104 configured to contain the toner (T) according to the present invention, a cleaning portion 105, an intermediate transfer member 106, a supporting roller 107, a transfer roller 108 and a charge eliminating means (not illustrated), which are disposed around the latent image bearer 101.

This image forming apparatus includes a paper feeding cassette (not illustrated) containing a plurality of sheets of recording paper (P) which is one example of a recording medium. The sheets of the recording paper (P) contained in the paper feeding cassette are retained with a pair of registration rollers (not illustrated) so as to be fed at a desired timing, and then fed one by one to between the intermediate transfer member 106 and the transfer roller 108 serving as the transfer means.

In this image forming apparatus, the latent image bearer 101 is uniformly charged with the charging device 102 while being rotatory driven clockwise in FIG. 3. Then, the latent image bearer 101 is irradiated with laser beams modulated by image date from the exposure device 103 to form an electrostatic latent image on the latent image bearer 101. The electrostatic latent image formed on the latent image bearer 101 is developed with the toner using the developing device 104.

Next, a toner image which has been formed by the developing device 104 is transferred from the latent image bearer 101 to the intermediate transfer member 106 by applying a transfer bias to the intermediate transfer member 106. Then, the sheet of the recording paper (P) is conveyed to between the intermediate transfer member 106 and the transfer roller 108, and the toner image is transferred onto the sheet of the recording paper (P).

The sheet of the recording paper (P) on which the toner image has been transferred is then conveyed to a fixing means (not illustrated).

The fixing means includes a fixing roller configured to be heated to a predetermined fixing temperature by a built-in heater, and a pressing roller configured to be pressed against the fixing roller with a predetermined pressure. The fixing means is configured to heat and press the sheet of the recording paper which has been conveyed by the transfer roller 108 to fix the toner image on the sheet, followed by ejecting the sheet onto a paper ejection tray (not illustrated).

In the image forming apparatus, the latent image bearer 101, from which the toner image has been transferred onto the sheet of the recording paper by the transfer roller 108, is further rotated. At the cleaning portion 105, the surface of the latent image bearer 101 is scraped to remove the toner remaining on the surface, followed by being charge-eliminated by a charge eliminating device (not illustrated).

Then, in the image forming apparatus, the latent image bearer 101, which has been charge-eliminated by the charge eliminating device, is uniformly charged by the charging device 102. Thereafter, the subsequent image is formed as described above.

Each member to be suitably used for an image forming apparatus according to the present invention will now be described in detail.

### <<Latent Image Bearer>>

A material, shape, structure, and size of the latent image bearer 101 are not particularly limited and may be appropriately selected from those know in the art. For example, the latent image bearer may suitably be drum-shaped or belt-shaped. The latent image bearer may be an inorganic latent image bearer made of, for example, amorphous silicon or selenium, or an organic latent image bearer made of, for example, polysilane or phthalopolymethine.

Of these, preferable are the amorphous silicon or the organic latent image bearer from the viewpoint of a long service life.

An electrostatic latent image can be formed on the latent image bearer 101 using an electrostatic latent image forming means by charging a surface of the latent image bearer 101 and then imagewise-exposing to light.

### <<Electrostatic Latent Image Forming Means>>

The electrostatic latent image forming means includes, for example, the charging device 102 configured to charge a surface of the latent image bearer 101 and the exposure device 103 configured to imagewise-expose the surface of the latent image bearer 101 to light.

Charging can be performed by, for example, applying voltage to the surface of the latent image bearer 101 using the charging device 102.

The charging device 102 is not particularly limited and may be appropriately selected depending on the intended purpose. Examples of the charging device include contact type chargers known per se including, for example, a conductive or semiconductive roller, a brush, a film and a rubber blade; and non-contact type chargers utilizing corona discharge such as corotron and scorotron.

The charging device 102 may be in any shape such as a roller as well as a magnetic brush and a fur brush. The shape may be selected according to specification or configuration of the image forming apparatus.

When the magnetic brush is used, the magnetic brush includes various ferrite particles (e.g., Zn—Cu ferrite) serving as a charging member, a non-magnetic conductive sleeve configured to support the ferrite particles, and a magnetic roller enclosed in the non-magnetic conductive sleeve.

When the brush is used, the fur brush may be made of a fur conductively treated with, for example, carbon, copper sulfide, a metal or a metal oxide. The fur may be coiled or mounted to a metal or other conductively treated cored bar to obtain the fur brush. The charging device 102 is not limited to the contact type chargers described above. However, the contact type chargers are preferably used from the viewpoint of producing the image forming apparatus in which a smaller amount of ozone is generated from the charger.

Exposure can be performing by, for example, imagewise-exposing the surface of the latent image bearer to light using the exposure device 103.

The exposure device 103 is not particularly limited and may be appropriately selected depending on the intended purpose, so long as the exposure device can imagewise-expose to light the surface of the latent image bearer 101, which has been charged by the charging device 102. Examples the exposure device include various exposure devices of, for example, a copy optical system, a rod lens array system, a laser optical system, and a liquid crystal shutter system.

Developing can be performed, for example, by developing the electrostatic latent image with the toner according to the present invention using the developing means 104.

### <<Developing Means>>

The developing device 104 serving as the developing means is not particularly limited and may be appropriately selected from those known in the art, so long as the developing device can perform the developing with the toner according to the present invention. Suitable example of the developing device includes a developing device containing the toner according to the present invention and including a developing device capable of applying the toner to the electrostatic latent image in a contact or non-contact manner.

The developing device 104 preferably includes a developing roller 140 and a thin layer-forming member 141. The developing roller is configured to bear a toner on a circumferential surface of the developing roller, to rotate with being in contact with the latent image bearer 101, and to supply a toner onto the electrostatic latent image, which has been formed on the latent image bearer 101, to develop the electrostatic latent image. The thin layer-forming member is configured to come into contact with the circumferential surface of the developing roller 140 to spread the toner on the developing roller 140 into a thin layer.

The developing roller 140 is suitably either a metal roller or an elastic roller. The metal roller is not particularly limited and may be appropriately selected depending on the intended purpose. Example of the metal roller includes an aluminium roller.

The metal roller may be subjected to blast treatment to relatively easily form the developing roller 140 having a desired surface friction coefficient.

Specifically, the aluminium roller may be subjected to glass bead blast treatment to roughen a surface of the roller, so that an appropriate amount of the toner can be deposited on the developing roller.

The elastic roller may be a roller coated with an elastic rubber layer. On the surface of the elastic roller, a surface coat layer, which is made of a material that is easily chargeable to polarity opposite to the toner, is disposed.

The elastic rubber layer is preferably set to have hardness of 60° or lower according to JIS-A, in order to prevent the toner from being deteriorated due to pressure concentration at a contact part with the thin layer-forming member 141.

The elastic roller is preferably set to have surface roughness (Ra) in a range of from 0.3 μm through 2.0 μm so as to retain a necessary amount of the toner on the surface of the elastic roller.

The elastic rubber layer is preferably set to have a resistance value in a range of from 10³Ω through 10¹⁰Ω because a developing bias is applied to the developing roller 140 in order to form an electrical field between the developing roller and the latent image bearer 101.

The developing roller 140 rotates clockwise to convey the toner borne on the surface of the developing roller to a position facing the thin layer-forming member 141 and the latent image bearer 101.

The thin layer-forming member 141 is disposed at a position that is lower than a position at which a supplying roller 142 is brought into contact with the developing roller 140.

The thin layer-forming member 141 is made of a metal plate spring material (e.g., stainless steel (SUS) or phosphor bronze). A free end of the thin layer-forming member is brought into contact with the surface of the developing roller 140 at pressure in a range of from 10 N/m through 40 N/m. The thin layer-forming member is configured to spread the toner, which has passed under the pressure, into a thin layer and to frictionally charge the toner.

In addition, in order to aid in frictionally charging, a regulation bias having a value offset from the developing bias in the same direction as charging polarity of the toner is applied to the thin layer-forming member 141.

A rubber elastic body, which a material of the surface of the developing roller 140, is not particularly limited and may be appropriately selected depending on the intended purpose. Examples of the rubber elastic body include styrene-butadiene copolymer rubber, acrylonitrile-butadiene copolymer rubber, an acrylic rubber, epichlorohydrin rubber, a urethane rubber, silicone rubber, or blends of any two or more thereof.

Of these, particularly preferable is a blend of the epichlorohydrin rubber and the acrylonitrile-butadiene copolymer rubber.

For example, the developing roller 140 is produced by coating a circumference of a conductive shaft with the rubber elastic body.

The conductive shaft is made of, for example, a metal such as stainless steel (SUS).

Transfer can be performed, for example, by charging the latent image bearer 101 using a transfer roller.

A preferable aspect of the transfer roller includes a primary transfer means and a secondary transfer means (transfer roller 108). The primary transfer means is configured to transfer the toner image on the intermediate transfer member 106 to form a transferred image. The secondary transfer means is configured to transfer the transferred image onto a sheet of the recording paper (P).

A more preferable aspect of the transfer roller uses two or more color toners, preferably full color toners, and includes a primary transfer means and a secondary transfer means. The primary transfer means is configured to transfer the toner image on the intermediate transfer member 106 to form a composite transferred image. The secondary transfer means is configured to transfer the composite transferred image onto a sheet of the recording paper (P).

Notably, the intermediate transfer member 106 is not particularly limited and may be appropriately selected from those known in the art. Suitable example of the intermediate transfer member includes a transfer belt.

In the present invention, the cleaning blade for an intermediate transfer member 120 preferably applies pressing force in a range of from 20 N/m through 50 N/m to the intermediate transfer member. At that time, a contact angle is adjusted to from 70° through 82° so as not to enlarge a contact portion of the cleaning blade for an intermediate transfer member 120 with the surface of the intermediate transfer member 106 to disperse force for preventing the external additive or the toner from passing through between the cleaning blade and the surface, the contact angle being formed between a tangential line extended from a point at which the cleaning blade for an intermediate transfer member 120 is brought into contact with the surface of the intermediate transfer member 106 and a surface of the cleaning blade for an intermediate transfer member 20 at a side of the intermediate transfer member 6.

When the pressing force is increased, the cleaning blade for an intermediate transfer member 120 elastically deforms to a greater extent adjacent to a portion at which the cleaning blade is brought into contact with the intermediate transfer member 106. As a result, a contact area of the cleaning blade with the intermediate transfer member tends to increase. However, it has been possible to prevent the cleaning blade from undesirably contacting with the intermediate transfer member, and to obtain, from the applied pressing force, sharply distributed force for preventing the toner from passing through between the cleaning blade and the intermediate transfer member. This is because a contact angle is adjusted to from 70° through 82°, the contact angle being formed between a tangential line extended from a point at which the cleaning blade for an intermediate transfer member 120 is brought into contact with the surface of the intermediate transfer member 106 and a surface of the cleaning blade for an intermediate transfer member 120 at a side of the intermediate transfer member 106.

The cleaning blade for an intermediate transfer member having the rebound resilience falling within a range of from 35% through 55% can elastically deform to adapt to unevenness in friction force generated in a longitudinal direction of the blade. Thus, the cleaning blade can stably contact with the intermediate transfer member.

The force for preventing the external additive or the toner from passing through is the lowest under a condition in which both of the cleaning blade for a latent image bearer and the cleaning blade for an intermediate transfer member have low rebound resilience, and the cleaning blade for a latent image bearer or the cleaning blade for an intermediate transfer member is brought in contact at low contact pressure and at a large contact angle. This is because, under L/L environment, both of the cleaning blade for a latent image bearer and the cleaning blade for an intermediate transfer member have low rebound resilience, and the cleaning blade for a latent image bearer or the cleaning blade for an intermediate transfer member is brought in contact at low contact pressure and at a large contact angle.

The cleaning blade for a latent image bearer and the cleaning blade for an intermediate transfer member are rolled up to the greatest extent under a condition in which both of the cleaning blade for a latent image bearer and the cleaning blade for an intermediate transfer member have high rebound resilience, and the cleaning blade for a latent image bearer or the cleaning blade for an intermediate transfer member is brought in contact at high contact pressure and at a small contact angle. This is because, under H/H environment, both of the cleaning blade for a latent image bearer and the cleaning blade for an intermediate transfer member have high rebound resilience, and the cleaning blade for a latent image bearer or the cleaning blade for an intermediate transfer member is brought in contact at high contact pressure and at a small contact angle.

The transfer means (primary transfer means or secondary transfer means) preferably includes a transfer device configured to transfer the toner image, which has been formed on the latent image bearer 101, toward the sheet of the recording paper (P) through charging. The number of the transfer means may be one, or two or more.

Examples of the transfer means include corona transfer devices using corona discharge, transfer belts, transfer rollers, pressure transfer rollers, and adhesive transfer devices.

Notably, typical example of the recording paper (P) includes plain paper. The recording paper, however, is not particularly limited and may be appropriately selected depending on the intended purpose, so long as an image which has been developed but unfixed can be transferred. PET bases used for OHP may be used.

Fixing can be performed, for example, on the toner image, which has been transferred onto the sheet of the recording paper (P), using a fixing means. The fixing may be performed every time when each color toner image is transferred onto sheet of the recording paper (P) or at one time after toner images of all colors are superposed.

The fixing means is not particularly limited and may be appropriately selected depending on the intended purpose, but is suitably known heat-press means.

Examples of the heat-press member include a combination of a heating roller and a pressing roller, and a combination of a heating roller, a pressing roller and an endless belt.

Notably, the heating temperature of the heat-press member is preferably in a range of from 80° C. through 200° C.

The fixing device may be a soft roller fixing device including a fluorine containing-surface layer as illustrated in FIG. 4.

A heating roller 109 includes an aluminium cored bar 110, an elastic body layer 111 made of silicone rubber, a tetrafluoroethylene-perfluoroalkylvinylether copolymer (PFA) surface layer 112, and a heater 113. The elastic body layer and the PFA surface layer are disposed on the aluminium cored bar. The heater is disposed inside the aluminium cored bar.

A pressing roller 114 includes an aluminium cored bar 115, an elastic body layer 116 made of silicone rubber, and a PFA surface layer 117. The elastic body layer and the PFA surface layer are disposed on the aluminium cored bar.

Notably, the sheet of the recording paper (P), on which an unfixed image 118 has been printed, is fed as illustrated.

Notably, in the present invention, a known optical fixing device may be used depending on the intended purpose in addition to or instead of the fixing means.

Charge eliminating can be performed, for example, by applying a charge eliminating bias to the latent image bearer, and can be suitably performed using a charge eliminating means.

The charge eliminating means is not particularly limited and may be appropriately selected from those known in the art, so long as the charge eliminating means can apply the charge eliminating bias to the latent image bearer. Example of the charge eliminating means includes charge eliminating lamps.

Cleaning can be suitably performed, for example, by removing the toner remaining on the latent image bearer using a cleaning means.

The cleaning means is not particularly limited and may be appropriately selected from those known in the art, so long as the cleaning means can remove the toner remaining on the latent image bearer. Suitable examples of the cleaning means include magnetic brush cleaners, electrostatic brush cleaners, magnetic roller cleaners, blade cleaners, brush cleaners, and web cleaners.

In the present invention, blade cleaning is preferable from the viewpoint of being the most inexpensive means.

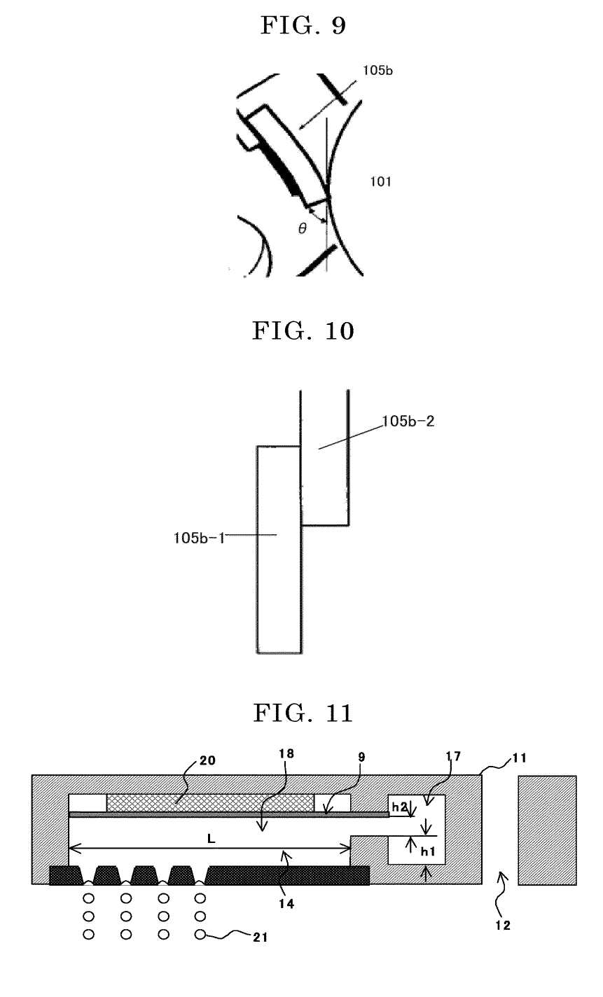

FIG. 8 is a diagram illustrating a cleaning device 105 used in the image forming apparatus according to the present invention, FIG. 9 is a specific explanatory diagram illustrating a cleaning portion, and FIG. 10 is a specific explanatory diagram illustrating a cleaning blade.

In FIG. 8, the cleaning portion 105 used for cleaning the toner deposited on the surface of the latent image bearer 101 includes a toner collecting case 105c, a movable member 105e, a tension spring 105f, and a screw 105g. The movable member is supported by a rocking lever shaft 105d disposed in the toner collecting case 105c and capable of rotating in a direction of the latent image bearer 101. In addition, a cleaning blade 105b can be disposed on the movable member. The tension spring is disposed on an end of the movable member 105e opposite to an end where the cleaning blade 105b is disposed taking the rocking lever shaft 105d as a center, and is configured to applying torque to the movable member 105e and pressing force against the latent image bearer 101 to the cleaning blade 105b. The screw is configured to transport the toner, which has been scraped from the surface of the latent image bearer 101 by contacting with the cleaning blade 105b, into the toner collecting case.

As illustrated in FIGS. 8 and 9, the cleaning blade 105b for a latent image bearer includes a plate cleaning blade 105b-1 and a supporting member 105b-2 configured to support the plate cleaning blade, as illustrated in FIG. 10. The cleaning blade 105b is used by pressing the plate cleaning blade 105b-1 against the surface of the latent image bearer 101, which is rotated in a direction indicated by the arrow (clockwise), at a predetermined contact angle θ by means of an urging member such as a spring.

As a material of the cleaning blade 105b-1, a material having hardness [JIS-A] in a range of from 60 through 80, elongation in a range of from 300% through 350%, elongation set in a range of from 1.0% through 5.0%, modulus at 300% in a range of from 100 kg/cm² through 350 kg/cm², and the rebound resilience in a range of from 10% through 35% is used. The material can be appropriately selected from resins commonly used for a plate blade member, such as thermoplastic resins (e.g., urethane resins, styrene resins, olefin resins, vinyl chloride resins, polyester resins, polyamide resins, and fluororesins).

A coefficient of friction of the cleaning blade is desirably low as possible.

A material of the supporting member 105b-2 is not particularly limited. Examples of the material include metals, plastics, and ceramics. However, metal plates are desirably used because force is applied to the supporting member to some extent. Steel plates such as SUS, aluminium plates, and phosphor bronze plates are particularly desirable.

When the toner is used, in typical blade cleaning systems, it is necessary to optimize the pressing force of the cleaning blade against the surface of the latent image bearer, and to improve the performance of stopping the external additive and the toner. This is because friction force increases at a contact portion of the cleaning blade 105b with the surface of the latent image bearer 101 as the pressing force increases. As a result, a contact edge of the cleaning blade 105b may be wound around in a rotational direction of the latent image bearer as the latent image bearer 101 is rotary driven, which causes the cleaning blade to be broken. If not broken, amplitude increases from repeated restorations by the action of elasticity due to the compression caused by winding the cleaning blade around the latent image bearer at least at the contact portion, adherence with the surface of the latent image bearer decreases, which causes cleaning failures due to passing through the external additive or the toner and prevents the stopper layer from forming to cause noise on an images. In the present embodiment, the pressing force in a range of from 20 N/m through 50 N/m is needed to be applied to the cleaning blade.

At that time, a contact angle is adjusted to from 70° through 82° so as not to enlarge a contact portion of the cleaning blade 105b with the surface of the latent image bearer 101 to disperse force for preventing the external additive or the toner from passing through between the cleaning blade and the surface, the contact angle being formed between a tangential line extended from a point at which the cleaning blade 105b is brought into contact with the surface of the latent image bearer and a surface of the cleaning blade 105b at a side of the latent image bearer 101.

When the pressing force is increased, the cleaning blade 105b elastically deforms to a greater extent adjacent to a portion at which the cleaning blade is brought into contact with the latent image bearer 101. As a result, a contact area of the cleaning blade with the latent image bearer tends to increase. However, it has been possible to prevent the cleaning blade from undesirably contacting with the latent image bearer, and to obtain, from the applied pressing force, sharply distributed force for preventing the toner from passing through between the cleaning blade and the latent image bearer. This is because a contact angle is adjusted to from 70° through 82°, the contact angle being formed between a tangential line extended from a point at which the cleaning blade 105b is brought into contact with the surface of the latent image bearer and a surface of the cleaning blade 105b at a side of the latent image bearer 101.

The cleaning blade having the rebound resilience falling within a range of from 10% through 35% can elastically deform to adapt to unevenness in friction force generated in a longitudinal direction of the blade. Thus, the cleaning blade can stably contact with the latent image bearer.

Recycling can be suitably performed, for example, by conveying the toner, which has been removed by the cleaning means, to the developing means using a recycling means.

The recycling means is not particularly limited and may be known conveying means.

Control can be suitably performed by controlling operation of each of the above means.

The control means is not particularly limited and may be appropriately selected depending on the intended purpose, so long as the control means is capable of controlling each of the above means. Example of the control means includes devices such as sequencers and computers.

The image forming apparatus, the image forming method, and the process cartridge according to the present invention can provide good images by using a toner for developing electrostatic latent images which is excellent in fixability and does not cause deterioration such as a crack due to stress applied during a developing process.

### <Multi-Color Image Forming Apparatus>

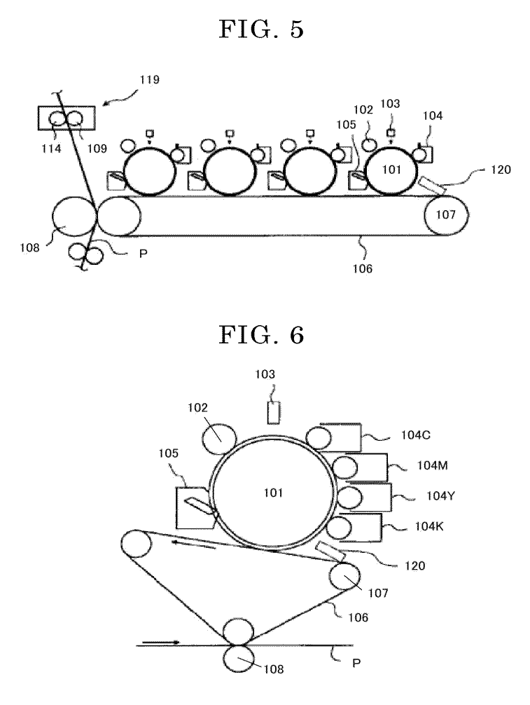

FIG. 5 is a schematic diagram illustrating one exemplary multi-color image forming apparatus according to the present invention.

In FIG. 5, a tandem-type full color image forming apparatus is illustrated.

In FIG. 5, image forming apparatus includes, in a main body casing (not illustrated), a latent image bearers 101 configured to be rotary driven clockwise in this drawing. The image forming apparatus further includes, for example, a charging device 102, an exposure device 103, a developing device 104, an intermediate transfer member 106, a supporting roller 107, and a transfer roller 108, which are disposed around the latent image bearers 101.

This image forming apparatus includes a paper feeding cassette (not illustrated) containing a plurality of sheets of recording paper. The sheets of the recording paper P contained in the paper feeding cassette are retained with a pair of registration rollers (not illustrated) so as to be fed at a desired timing, and then fed one by one to between the intermediate transfer member 106 and the transfer roller 108 and fixed by a fixing means 119.

In this image forming apparatus, the latent image bearer 101 is uniformly charged with the charging device 102 while being rotatory driven clockwise in FIG. 5. Then, the latent image bearer 101 is irradiated with laser beams modulated by image date from the exposure device 103 to form an electrostatic latent image on the latent image bearer 101. The electrostatic latent image formed on the latent image bearer 101 is developed with the toner using the developing device 104.

Next, a toner image, which has formed by applying the toner to the latent image bearer using the developing device 104, is transferred from the latent image bearer 101 to the intermediate transfer member.

The above-described procedures are repeatedly performed in four colors of cyan (C), magenta (M), yellow (Y) and black (K), to form a full color toner image. Reference numeral 120 denotes a cleaning blade for an intermediate transfer member.

FIG. 6 is a schematic diagram illustrating one exemplary revolver type-full color image forming apparatus. This image forming apparatus is configured to switch operations of each developing device to sequentially develop images with a plurality of color toners on one latent image bearer 101.

The transfer roller 108 is used to transfer a color toner image from the intermediate transfer member 106 onto the sheet of the recording paper P. Then, the sheet of the recording paper P on which the toner image has been transferred is conveyed to a fixing portion to obtain a fixed image.

In the image forming apparatus, the latent image bearer 101, from which the toner image has been transferred via the intermediate transfer member 106 onto the sheet of the recording paper P, is further rotated. At the cleaning portion 105, the surface of the latent image bearer 101 is scraped with the blade to remove the toner remaining on the surface, followed by being charge-eliminated at a charge eliminating portion.

Then, in the image forming apparatus, the latent image bearer 101, which has been charge-eliminated by the charge eliminating portion, is uniformly charged by the charging device 102. Thereafter, the subsequent image is formed as described above.

Notably, the cleaning portion 105 is not limited to those configured to scrape with the blade the toner remaining on the latent image bearer 101. For example, a fur brush may be used to scrape the toner remaining on the latent image bearer 101. Reference numeral 120 denotes a cleaning blade for an intermediate transfer member.

The image forming method and the image forming apparatus according to the present invention can result in good images because the toner according to the present invention is used as the developer.

### <Process Cartridge>

A process cartridge according to the present invention includes an electrostatic latent image bear configured to bear the electrostatic latent image and a developing means configured to develop the electrostatic latent image on the electrostatic latent image bearer with the toner according to the present invention to form a visible image; and, if necessary, further includes appropriately selected other means such as a charging means, a developing means, a transfer means, a cleaning means and a charge eliminating means. The process cartridge is detachably mounted to a main body of the image forming apparatus.

The developing means includes, for example, a developer container configured to contain the toner or the developer, and a developer bearer configured to bear and convey the toner or the developer contained in the developer container; and may further include, for example, a layer thickness-regulating member configured to regulate a thickness of a toner layer to be borne.

The process cartridge according to the present invention can be detachably mounted to various electrophotographic apparatuses, facsimiles, or printers, but preferably detachably mounted to the image forming apparatus according to the present invention described below.

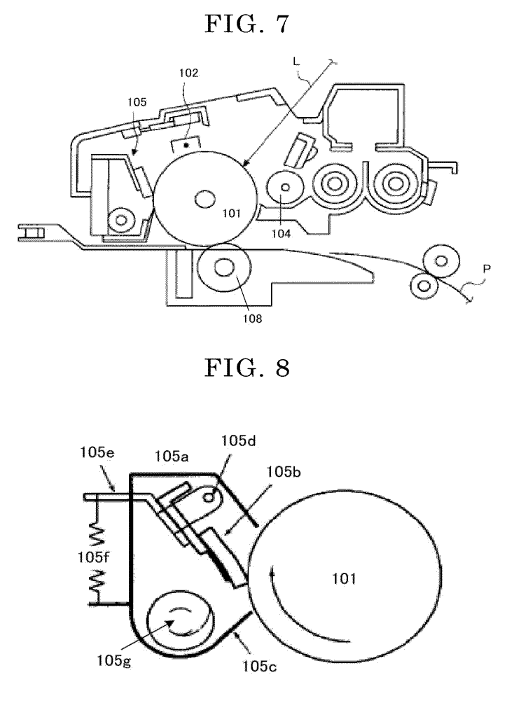

As illustrated in FIG. 7, the process cartridge includes a built-in latent image bearer 101, a charging device 102, a developing device 104, a transfer roller 108, and a cleaning portion 105; and, if necessary, further includes other means.

In FIG. 7, (L) denotes light emitted from an exposure device and (P) denotes a sheet of recording paper.

The latent image bearer 101 may be the same as those used in the image forming apparatus.

The charging device 102 may be any charging member.

Next, an image forming process using the process cartridge illustrated in this drawing will now be described. The latent image bearer 101 is charged with the charging device 102 and then is exposed to light (L) emitted from an exposure means (not illustrated) while being rotated in a direction indicated by the arrow, to form an electrostatic latent image corresponding to an exposure image on the surface of the latent image bearer. The electrostatic latent image is developed with the toner by the developing device 104. The image, which has been developed with the toner, is transferred onto the sheet of the recording paper sheet (P) by the transfer roller 108, and then printed out.

Next, the surface of the latent image bearer, from which the toner image has been transferred, is cleaned at the cleaning portion 105, and is charge-eliminated by a charge eliminating means (not illustrated). Then, the above-described procedures are repeatedly performed.

### EXAMPLES

Examples of the present invention now will be described, but the present invention is not limited Examples described below. Unless otherwise stated, “part(s)” means “part(s) by mass” and “%” means “% by mass.”

A method for analyzing and evaluating toners produced in Examples and Comparative Examples will be described.

Hereinafter, the toner according to the present invention was evaluated for the case of being used as a one component developer. However, the toner according to the present invention may be used as a two component developer using in combination with a suitable external additive and a suitable carrier.

### <Measurement Method>

### <<Method for Separating External Additive in Toner>>

Two grams of the toner was added into 30 mL of a surfactant solution (10-fold diluted), and mixed together sufficiently. Then, the toner was separated by applying energy at 40 W for 5 min using an ultrasonic homogenizer, followed by cleaning and then drying. Thus, the external additive was separated from the toner. Thus-separated external additive was used as a sample to measure an amount of free silicone oil in the external additive by the following method.

### <<Method for Measuring Amount of Free Silicone Oil>>

A free silicone oil amount (amount of free silicone oil) was measured by a quantitative method including the following steps (1) to (3):

(1) A sample for extracting the free silicone oil was immersed in chloroform, stirred, and left to stand.

A supernatant was removed by centrifugation to obtain a solid content. Chloroform was added to the solid content, stirred, and left to stand.

The above procedures were repeated to remove the free silicone oil from the sample.

(2) Quantification of carbon content

A carbon content in the sample from which the free silicone oil had been removed was quantified by a CHN elemental analyzer (CHN CORDER MT-5; product of Yanaco Technical Science Co., Ltd.).

(3) A quantitative amount of the free silicone oil was calculated by the following Expression (1):

Amount of free silicone oil=(C₀−C₁)/C×100×40/12 (% by mass) Expression (1)

where
“C” denotes a carbon content (% by mass) in the silicone oil serving as a treating agent,
“C₀” denotes a carbon content (% by mass) in the sample before the extraction,
“C₁” denotes a carbon content (% by mass) in the sample after the extraction, and
the coefficient “40/12” denotes a conversion factor for converting the carbon content in a structure of polydimethylsiloxane (PDMS) to the total amount of PDMS.

The structural formula of polydimethylsiloxane is illustrated below.

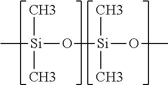

### <<Average Particle Diameter>>

A method for measuring a particle size distribution of toner particles will now be described.

Examples of a device for measuring a particle size distribution of toner particles using a coulter counter method include COULTER COUNTER TA-II and COULTER MULTISIZER II (these products are of Beckman Coulter, Inc.).

A measurement method is as follows.

Firstly, from 0.1 mL through 5 mL of a surfactant (preferably alkylbenzene sulfonate) serving as a dispersant was added to from 100 mL through 150 mL of an electrolyte solution.

Here, the electrolyte solution was an about 1% aqueous NaCl solution prepared using let grade sodium chloride, and ISOTON-II (product of Coulter, Inc.) was used as the electrolyte solution.

Subsequently, a measurement sample (solid content: from 2 mg through 20 mg) was added to and suspended in the electrolyte solution.

The resultant electrolyte solution was dispersed with an ultrasonic disperser for from about 1 min through about 3 min, followed by measuring the number and volume of the toner particles or the toner with the above-described device (COULTER MULTISIZER II) using an aperture of 100 m. Based on the number and the volume, a volume distribution (volume basis particle size distribution) and a number distribution were calculated.

From thus-obtained distributions, a volume average particle diameter (Dv) and a number average particle diameter (Dn) of the toner were determined.

Notably, 13 channels were used: 2.00 μm or more but less than 2.52 μm; 2.52 μm or more but less than 3.17 μm; 3.17 μm or more but less than 4.00 μm; 4.00 μm or more but less than 5.04 μm; 5.04 μm or more but less than 6.35 μm; 6.35 μm or more but less than 8.00 μm; 8.00 μm or more but less than 10.08 μm; 10.08 μm or more but less than 12.70 μm; 12.70 μm or more but less than 16.00 μm; 16.00 μm or more but less than 20.20 μm; 20.20 μm or more but less than 25.40 μm; 25.40 μm or more but less than 32.00 μm; and 32.00 μm or more but less than 40.30 μm; i.e., particles having a particle diameter of 2.00 μm or more but less than 40.30 μm were subjected to the measurement.

### <<Average Circularity>>

An optical sensing method is appropriately used for measuring shape. In the optical sensing method, a suspension liquid containing particles is allowed to pass through a plate-like sensing band in an imaging portion, during which images of the particles are optically sensed and analyzed by a CCD camera.

A circumferential length of a circle having an area equal to a projected area of the particle is divided by a circumferential length of an actual particle, which is determined as an average circularity.

Thus-determined value refers to a value measured as the average circularity using a flow-type particle image analyzer FPIA-3000.

Specifically, from 0.1 mL through 0.5 mL of a surfactant (preferably alkylbenzene sulfonate) serving as a dispersant was added to from 100 mL through 150 mL of water, from which solid impurities had previously been removed, in a container. Then, from about 0.1 g through about 0.5 g of a measurement sample was added to the container and dispersed to obtain a suspension liquid.

The suspension liquid was dispersed with an ultrasonic disperser for from about 1 min through about 3 min. A shape and a distribution of the toner were measured using the analyzer at a concentration of the resultant dispersion liquid of from 3,000 particles per microliter through 10,000 particles per microliter.

### <<Molecular Weight>>

A molecular weight of, for example, a polyester resin to be used was measured by a commonly used gel permeation chromatography (GPC) under the following conditions.

Device: HLC-8220GPC (product of Tosoh Corporation)

Column: TSK GEL SUPER HZM-M×3

Temperature: 40° C.

Solvent: tetrahydrofuran (THF)

Flow rate: 0.35 mL/min

Sample: 0.01 mL of the sample having a concentration of from 0.05% through 0.6% was injected.

From a molecular weight distribution of a toner resin measured under the above conditions, a weight average molecular weight Mw was calculated using a molecular weight calibration curve produced from a monodispersed polystyrene standard sample.

As for the monodispersed polystyrene standard sample, the following 10 samples having the weight average molecular weights of

5.8×100,
1.085×10,000,
5.95×10,000,
3.2×100,000,
2.56×1,000,000,
2.93×1,000,
2.85×10,000,
1.48×100,000,
8.417×100,000, and
7.5×1,000,000
were used.

### <<Glass Transition Temperature and Endothermic Amount>>

A glass transition temperature of, for example, a polyester resin to be used was measured by using a differential scanning calorimeter (e.g., DSC-60: available from SHIMADZU CORPORATION) as follows.

A sample is heated from room temperature to 150° C. at a heating rate of 10° C./min; cooled to room temperature; and then heated again to 150° C. at a heating rate of 10° C./min. The glass transition temperature was determined from a base line at a temperature equal to or lower than the glass transition temperature and a curved line portion in which a height of the base line corresponds to ½ at a temperature equal to or higher than the glass transition temperature.

Endothermic amounts and melting points of, for example, a release agent and a crystalline resin were measured in the same manner.

The endothermic amount was determined by calculating a peak area of a measured endothermic peak.

Generally, the release agent contained in the toner melts at a temperature lower than a fixing temperature of the toner. Heat of melting generated when the release agent melts appears as the endothermic peak.

In some release agents, heat of transition due to phase transition in a solid phase may be generated in addition to the heat of melting. In the present invention, the sum of the heat of transition and the heat of melting was determined as the endothermic amount of the heat of melting.

### <<Specific Surface Area>>

A BET specific surface area of the external additive was measured using a surface area analyzer AUTOSORB-1 (product of Quantachrome Instruments) as follows.

About 0.1 g of a measurement sample was weighed into a cell, and degassed at a temperature of 40° C. and the degree of vacuum of 1.0×10⁻³ mmHg or lower for 12 hours or longer.

Then, nitrogen gas was allowed to be adsorbed on the sample while cooling with liquid nitrogen, and the value of the BET specific surface area was determined by a multi-point method.

### <<Particle Diameter of External Additive>>

A particle diameter (average primary particle diameter) of the external additive can be measured by a device for measuring a particle diameter distribution utilizing dynamic light scattering (e.g., DLS-700 (product of Otsuka Electronics Co., Ltd.) or COULTER N4 (product of Beckman Coulter, Inc.)).

However, the particle diameter is preferably determined directly from a photograph taken by a scanning electron microscope or a transmission electron microscope, because secondary aggregates of silicone-oil-treated particles are difficult to separate from each other.

In this case, at least 100 or more inorganic particles are observed, and major axes of the inorganic particles are averaged.

In Examples, the scanning electron microscope S-4200 (product of Hitachi, Ltd.) was used for the measurement.

### <<Rebound Resilience of Cleaning Blade>>

Rebound resilience was measured by a Lupke type rebound resilience tester (product of Yasuda Seiki Seisakusho, Ltd.) at 23° C. in accordance with JIS K6255.

### <<Contact Pressure of Cleaning Blade>>

Contact force of the cleaning blade was measured by preparing a metal tube having the same diameter as the latent image bearer, setting the metal tube so that a portion having a width of 5 mm in a longitudinal direction was movable, and disposing a load cell on a back side of a movable plane to measure pressing force per length. The resultant pressing force per length was determined as the contact pressure.

A method for preparing raw materials of the toner used in Examples will now be described.

### <Method for Treating External Additive>

### <<Silica 1>>

A predetermined amount of polydimethylsiloxane serving as silicone oil (viscosity: 300 cs; product of Shin-Etsu Chemical Co., Ltd.) was dissolved into hexane (30 parts). An external additive to be treated (OX50, untreated silica, primary average particle diameter: 35 nm, product of Nippon Aerosil Co., Ltd.) (100 parts) was dispersed in the resultant solution with stirring and ultrasonic irradiation.

The resultant dispersion was purged with nitrogen, introduced under stirring so as to give a silicone oil content described in Table 1-1, and then treated at a reaction temperature for a reaction time as described in Table 1-1 with stirring to obtain [Silica 1].

[Silica 2] to [Silica 6] were obtained in the same manner as in the [Silica 1], except for those described in Tables 1-1 and 1-2.

TABLE 1-1

| | | | | | | Particle |
|---|---|---|---|---|---|---|
| | Added | | | BET | | diameter |
| | amount | Treat- | Treat- | specific | Silicone | of |
| | of | ment | ment | surface | oil | external |
| | PDMS | temeprature | time | area | content | additive |
| | (part) | ° C. | min | m²/g | mg/m² | nm |
| Silica | 10 | 150 | 15 | 50 | 2 | 35 |
| 1 | | | | | | |
| Silica | 20 | 200 | 15 | 50 | 4 | 35 |
| 2 | | | | | | |
| Silica | 20 | 200 | 15 | 50 | 4 | 35 |
| 3 | | | | | | |
| Silica | 20 | 150 | 15 | 50 | 4 | 35 |
| 4 | | | | | | |
| Silica | 8 | 200 | 15 | 50 | 1.6 | 35 |
| 5 | | | | | | |
| Silica | 0 | 200 | 15 | 50 | 0 | 35 |
| 6 | | | | | | |

TABLE 1-2

| | PDMS amount in | | | | Amount of | Amount of |
|---|---|---|---|---|---|---|
| | external additive | | Rate of | Rate of | free | remaining |
| | Before | After | free | remaining | PDMS in | PDMS in |
| | extrac- | extrac- | PDMS in | PDMS in | external | external |
| | tion | tion | external | external | additive | additive |
| | % by | % by | additive | additive | % by | % by |
| | mass | mass | % | % | mass | mass |
| Silica | 10.3 | 2.0 | 81 | 19 | 8.3 | 2.0 |
| 1 | | | | | | |
| Silica | 19.3 | 8.3 | 57 | 43 | 11.0 | 8.3 |
| 2 | | | | | | |
| Silica | 20.7 | 7.0 | 66 | 34 | 13.7 | 7.0 |
| 3 | | | | | | |
| Silica | 19.7 | 2.7 | 86 | 14 | 17.0 | 2.7 |
| 4 | | | | | | |
| Silica | 9.3 | 5.7 | 39 | 61 | 3.7 | 5.7 |
| 5 | | | | | | |
| Silica | 0.0 | 0.0 | 0 | 0 | 0.0 | 0.0 |
| 6 | | | | | | |

### Production Example 1

### Production of Toner Base Particles 1

### Toner Producing Apparatus

A toner producing apparatus 1 having a configuration illustrated in FIG. 16 and some discharging means were used to produce toners.

Size and conditions of each member will now be described.

### —Liquid Column Resonance Liquid Droplet Discharging Means—

A liquid column resonance liquid droplet discharging means in which a length L between both ends of the liquid column resonance liquid chamber 18 in a longitudinal direction was 1.85 [mm]; a resonance mode (N=2) was used; and the first to fourth discharge holes were disposed at positions corresponding to anti-nodes of a pressure standing wave having the resonance mode (N=2), was used. A drive signal-generating source was FUNCTION GENERATOR WF1973 (product of NF Corporation, Ltd.) and was coupled to a vibration generating means via a polyethylene coated-lead wire. A driving frequency was 340 [kHz] in accordance with a liquid resonance frequency.

### —Toner Collecting Portion—

A chamber 61 was cylindrical-shaped having an inner diameter of 400 mm and a height of 2,000 mm. The chamber was secured in a vertical direction, and tapered at top and bottom ends. A diameter of a conveying gas stream inlet port was 50 mm and a diameter of a conveying gas stream outlet port was also 50 mm. A liquid droplet discharging means 2 was disposed at a center of the chamber 61 at a position 300 mm apart from a top end of the chamber 61. Also, the conveying gas stream was nitrogen gas at 40° C. having velocity of 8.0 m/s.

### <<Preparation of Colorant Dispersion Liquid>>

Firstly, as a colorant, a carbon black dispersion liquid was prepared.

Carbon black (REGAL 400; product of Cabot Corporation) (17 parts) and a pigment dispersant (AJISPER PB821; product of Ajinomoto Fine-Techno Co., Inc.) (3 parts) were primarily dispersed in ethyl acetate (80 parts) with a mixer having a stirring blade. The resultant primary dispersion liquid was dispersed more finely with strong shearing force using a bead mill (type LMZ, product of Ashizawa Finetech Ltd., zirconia bead diameter: 0.3 mm), to prepare a secondary dispersion liquid (colorant dispersion liquid) from which aggregates of 5 μm or more had been completely removed.

### <<Preparation of Wax Dispersion Liquid>>

Next, a wax dispersion liquid was prepared.

Carnauba wax (WA-05, product of CERARICA NODA Co., Ltd.) (18 parts) and a wax dispersant (2 parts) were primarily dispersed in ethyl acetate (80 parts) with a mixer having a stirring blade. The resultant primary dispersion liquid was heated to 80° C. with stirring to dissolve the carnauba wax, and then cooled to room temperature to deposit wax particles so as to have the maximum diameter of 3 μm or less. The wax dispersant was polyethylene wax to which a styrene-butyl acrylate copolymer had been grafted. The thus obtained dispersion liquid was dispersed more finely with strong shear force using a bead mill (type LMZ, product of Ashizawa Finetech Ltd., zirconia bead diameter: 0.3 mm) so as to adjust the maximum particle diameter of wax particles to 1 μm or less. Thus, a wax dispersion liquid was obtained.

### <<Preparation of Solution or Dispersion Liquid>>

Next, a toner component liquid including a resin serving as the binder resin, the colorant dispersion liquid, and the wax dispersion liquid and having the following composition was prepared.

Noncrystalline polyester resin 1 (Mw: 20,000, acid value: 5 mgKOH/g, Tg: 55° C.) (10 parts) was dissolved in ethyl acetate (90 parts) with a mixer having a stirring blade to obtain a solution. Then, a cationic fluorosurfactant F150 (product of DIC Corporation) (pure content: 0.3 parts) was added to the solution, followed by stirring at 50° C. for 30 min to produce Solution 1.

Then, the Noncrystalline polyester resin 1 serving as the binder resin (90 parts), the colorant dispersion liquid (30 parts), and the wax dispersion liquid (30 parts) was uniformly dissolved or dispersed in ethyl acetate (750 parts) by stirring for 10 min with a mixer having a stirring blade. To this, was added the Solution 1, followed by uniformly mixing to obtain a toner component liquid. There was no aggregation of particles of the pigment or the wax due to shock upon dissolution or dispersion.

### <<Production of Toner>>

The above-described toner producing apparatus was used to discharge the resultant toner component liquid, followed by drying and solidifying in a chamber to obtain toner particles. The resultant toner particles were collected by a cyclone collector to obtain Pre-classified toner base particles 1.

### —Classification of Toner Particles—

The Pre-classified toner base particles 1 were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 10 times to classify the toner particles. Post-classified slurry was separated through filtration. The resultant filter cake was dried under reduced pressure at 40° C. for 24 hours to obtain Toner base particles 1.

### Production Example 2

### Production of Toner Base Particles 2

Toner base particles 2 were obtained using the above-described toner producing apparatus in the same manner as in Production example 1, except that the toner particles were not classified.

### Production Example 3

### Production of Toner Base Particles 3

Toner base particles 3 were obtained using the above-described toner producing apparatus in the same manner as in Production example 2, except that the conveying gas stream was at 2.0 m/s.

### Production Example 4

### Production of Toner Base Particles 4

Toner base particles 4 were obtained using the above-described toner producing apparatus in the same manner as in Production example 2, except that the conveying gas stream was at 6.0 m/s.

### Production Example 5

### Production of Toner Base Particles 5

The Pre-classified toner base particles 1, which had been produced using the above-described toner producing apparatus in the same manner as in Production example 1, were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 20 times to classify the toner particles. Post-classified slurry was separated through filtration. The resultant filter cake was dried under reduced pressure at 40° C. for 24 hours to obtain Toner base particles 5.

### Production Example 6

### Production of Toner Base Particles 6

The Pre-classified toner base particles 1, which had been produced using the above-described toner producing apparatus in the same manner as in Production example 1, were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 14 times to classify the toner particles. Post-classified slurry was separated through filtration. The resultant filter cake was dried under reduced pressure at 40° C. for 24 hours to obtain Toner base particles 6.

### Production Example 7

### Production of Toner Base Particles 7

Toner base particles 7 were obtained using the above-described toner producing apparatus in the same manner as in Production example 2, except that the conveying gas stream was at 0.0 m/s.

### Production Example 8

### Production of Toner Base Particles 8

The Pre-classified toner base particles 1, which had been produced using the above-described toner producing apparatus in the same manner as in Production example 1, were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 12 times to classify the toner particles. Post-classified slurry was separated through filtration. The resultant filter cake was dried under reduced pressure at 40° C. for 24 hours to obtain Toner base particles 8.

### Production Example 9

### Production of Toner Base Particles 9

Toner base particles 9 were obtained in the same manner as in Production example 2, except that the conveying gas stream was at 1.0 m/s.

### Production Example 10

### Production of Toner Base Particles 10

Pre-classified toner base particles 10 were obtained in the same manner as in Production example 1, except that the conveying gas stream was at 6.0 m/s.

The resultant Pre-classified toner base particles 10 were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 14 times to classify the toner particles. Post-classified slurry was separated through filtration. The resultant filter cake was dried under reduced pressure at 40° C. for 24 hours to obtain Toner base particles 10.

### Production Example 11

### Production of Toner Base Particles 11

Pre-classified toner base particles 11 were obtained in the same manner as in Production example 1, except that the conveying gas stream was at 0.0 m/s.

The resultant Pre-classified toner base particles 11 were placed into a water tank containing water and an aqueous sodium dodecyl diphenyl ether disulfonate solution (“ELEMINOL MON-7”, product of Sanyo Chemical Industries) in an amount of 0.5 parts (pure content) relative to 100 parts of water, to obtain toner particle dispersion liquid. The resultant toner particle dispersion liquid was stirred and filtered off, and then the resultant filter cake was redispersed in distilled water and filtered. These procedures were repeated 10 times to classify the toner particles. Post-classified slurry was separated through filtration. The resultant filter cake was dried under reduced pressure at 40° C. for 24 hours to obtain Toner base particles 11.

### Example 1

### External Addition of Toner

The Toner base particles 1 (100 parts), the Silica 6 described in Tables 1-1 and 1-2 (3 parts), and hydrophobic silica (primary particle diameter: about 10 nm) [hexamethyldisilazane (HMDS) treated external additive] (1 part) were mixed together in Henschel mixer to obtain a developer of Example 1.

### Examples 2 to 10, Comparative Examples 1 to 7

### External Addition of Toner

Developers of Examples 2 to 10 and Comparative Examples 1 to 7 were obtained in the same manner as in Example 1, except that silica described in Tables 1-1 and 1-2 was used in types and amounts described in Tables 2-1 and 2-2.

The resultant developers were evaluated as follows.

### (Evaluation Method 1)

### <Cleanability of Latent Image Bearer, Film Abrasion Amount, and Contamination of Regulation Blade>

### <<Cleanability of Latent Image Bearer (1)>>

A predetermined print pattern having a B/W ratio of 6% was continuously printed on 2,000 sheets with a monochrome mode using IPSIO SP C220 (product of Ricoh Company, Ltd.) under N/N environment (23° C., 45%).

A cleaning blade had rebound resilience of 30% and was brought into contact with a latent image bearer at contact pressure of 30 N/m and at a contact angle of 75°.

After completion of the printing on the 2,000 sheets, the toner remaining on the latent image bearer was removed by a piece of tape (T-TAPE, product of Kihara Corporation), and was measured for L* using a spectrophotometer XRITE 939 (product of X-Rite Inc.). The result was evaluated according to the following criteria.

### [Evaluation Criteria]

A: 90 or higher
B: 85 or higher but lower than 90
C: 80 or higher but lower than 85
D: lower than 80

### <<Cleanability of Latent Image Bearer (2)>>

A predetermined print pattern having a B/W ratio of 6% was continuously printed on 2,000 sheets with a monochrome mode using IPSIO SP C220 (product of Ricoh Company, Ltd.) under L/L environment (10° C., 15%).

A cleaning blade had rebound resilience of 10% and was brought into contact with a latent image bearer at contact pressure of 20 N/m and at a contact angle of 82°.

Under this condition, force for preventing the external additive or the toner from passing through is the lowest because, under the L/L environment, the cleaning blade has low rebound resilience, and is brought into contact with the latent image bearer at low contact pressure and at a large contact angle.

After completion of the printing on the 2,000 sheets under the above condition, the toner remaining on the latent image bearer was removed by a piece of tape (T-TAPE, product of Kihara Corporation), and was measured for L* using a spectrophotometer XRITE 939 (product of X-Rite Inc.). The result was evaluated according to the following criteria.

### [Evaluation Criteria]

A: 90 or higher
B: 85 or higher but lower than 90
C: 80 or higher but lower than 85
D: lower than 80

### <<Cleanability of Latent Image Bearer (3)>>

A predetermined print pattern having a B/W ratio of 6% was continuously printed on 2,000 sheets with a monochrome mode using IPSIO SP C220 (product of Ricoh Company, Ltd.) under H/H environment (27° C., 80%).

A cleaning blade had rebound resilience of 35% and was brought into contact with a latent image bearer at contact pressure of 50 N/m and at a contact angle of 70°.

Under this condition, the cleaning blade is broken and rolled up to the greater extent because, under the H/H environment, the cleaning blade has high rebound resilience, and is brought in contact at high contact pressure and at a small contact angle.

During the printing on 2,000 sheets under the above condition, the number of the sheets printed with the cleaning blade being rolled up was counted, and the result was evaluated according to the following criteria.

### [Evaluation Criteria]

A: 2,000 sheets or more
B: 1,800 sheets or more but less than 2,000 sheets
C: 1,600 sheets or more but less than 1,800 sheets
D: less than 1,600 sheets

### <<Film Abrasion Amount of Latent Image Bearer>>

A film abrasion amount of the latent image bearer was measured by measuring film thicknesses before and after evaluating the Cleanability of latent image bearer (1).

The film thicknesses were measured at any 80 measurement points using an eddy current film thickness analyzer (product of Fischer Instruments K.K.) and averaged to determine the film abrasion amount of latent image bearer. The obtained film abrasion amount was evaluated according to the following criteria.

### [Evaluation Criteria]

A: 0.3 μm or less
B: more than 0.3 μm but 0.4 μm or lower
C: more than 0.4 μm but 0.6 μm or lower
D: more than 0.6 μm

### <<Contamination of Regulation Blade>>

A difference in charging amounts of the toner before and after evaluating the Cleanability of latent image bearer (1) was measured, and the degree of contamination of a regulation blade was evaluated.

The charging amount was measured using a compact suction type charging amount measuring device (product of TREK Japan K.K.) disposed on a developing roller, and the charge amounts measured at 10 points were averaged. The result was evaluated according to the following criteria.

### [Evaluation Criteria]

A: difference in charging amounts of 5 μC/g or less
B: difference in charging amounts of more than 5 μC/g but 10 μC/g or less
C: difference in charging amounts of more than 10 μC/g but 15 μC/g or less
D: difference in charging amounts of more than 15 μC/g

### (Evaluation Method 2)

### <Cleanability of Intermediate Transfer Member, Film Abrasion Amount, and Contamination of Regulation Blade>

### <<Cleanability of Intermediate Transfer Member (1)>>

A predetermined print pattern having a B/W ratio of 6% was continuously printed on 2,000 sheets with a monochrome mode using IPSIO SP C220 (product of Ricoh Company, Ltd.) under L/L environment (10° C., 15%).

A cleaning blade for an intermediate transfer member had rebound resilience of 35% and was brought into contact with a latent image bearer at contact pressure of 20 N/m and at a contact angle of 82°.

Under this condition, force for preventing the external additive or the toner from passing through is the lowest because, under the L/L environment, the cleaning blade has low rebound resilience, and is brought into contact with an intermediate transfer member at low contact pressure and at a large contact angle.

After completion of the printing on the 2,000 sheets under the above condition, the toner remaining on the intermediate transfer member was removed by a piece of tape (T-TAPE, product of Kihara Corporation), and was measured for L* using a spectrophotometer XRITE 939 (product of X-Rite Inc.). The result was evaluated according to the following criteria.

### [Evaluation Criteria]

A: 90 or higher
B: 85 or higher but lower than 90
C: 80 or higher but lower than 85
D: lower than 80

### <<Cleanability of Intermediate Transfer Member (2)>>

A predetermined print pattern having a B/V ratio of 6% was continuously printed on 2,000 sheets with a monochrome mode using IPSIO SP C220 (product of Ricoh Company, Ltd.) under H/H environment (27° C., 80%).

A cleaning blade had rebound resilience of 56% and was brought into contact with a latent image bearer at contact pressure of 50 N/m and at a contact angle of 70°.

Under this condition, the cleaning blade for an intermediate transfer member is broken and rolled up to the greater extent because, under the H/H environment, the cleaning blade has high rebound resilience, and is brought in contact at high contact pressure and at a small contact angle.

During the printing on 2,000 sheets under the above condition, the number of the sheets printed with the cleaning blade being rolled up was counted, and the result was evaluated according to the following criteria.

### [Evaluation Criteria]

A: 2,000 sheets or more
B: 1,800 sheets or more but less than 2,000 sheets
C: 1,600 sheets or more but less than 1,800 sheets
D: less than 1,600 sheets

### <<Abrasion Amount of Intermediate Transfer Member>>

The number of vertical streaks formed in the intermediate transfer member was measured before and after evaluating the Cleaning property of intermediate transfer member (1) to measure an abrasion amount. The result was evaluated according to the following criteria.

### [Evaluation Criteria]

A: 5 or less
B: more than 5 but 10 or less
C: more than 10 but 20 or less
D: more than 20

### <<Evaluation of Image Stability (1)>>

A predetermined print pattern having a B/W ratio of 6% was continuously printed on 2,000 sheets with a monochrome mode using IPSIO SP C220 (product of Ricoh Company, Ltd.) under N/N environment (23° C., 45%).

A cleaning blade had rebound resilience of 30% and was brought into contact at contact pressure of 30 N/m and at a contact angle of 75°.

After completion of the printing on the 2,000 sheets, image quality (image density, fine line reproducibility, and background fog) was evaluated according to the following criteria.

### [Evaluation Criteria]

A: A good image comparable to the initial image was obtained.
B: Any of evaluation items of image density, fine line reproducibility, and background fog changed at an acceptable level compared with the initial image.
C: All of the evaluation items of image density, fine line reproducibility, and background fog changed at an acceptable level compared with the initial image.
D: Any of the evaluation items of image density, fine line reproducibility, and background fog apparently changed at an unacceptable level compared with the initial image.

### <<Evaluation of Image Stability (2)>>

A predetermined print pattern having a B/W ratio of 6% was continuously printed on 2,000 sheets with a monochrome mode using IPSIO SP C220 (product of Ricoh Company, Ltd.) under N/N environment (23° C., 45%).

A cleaning blade had rebound resilience of 30% and was brought into contact at contact pressure of 30 N/m and at a contact angle of 75°.

After completion of the printing on the 50,000 sheets, image quality (image density, fine line reproducibility, and background fog) was evaluated according to the following criteria.

### [Evaluation Criteria]

A: A good image comparable to the initial image was obtained.
B: Any of evaluation items of image density, fine line reproducibility, and background fog changed at an acceptable level compared with the initial image.
C: All of the evaluation items of image density, fine line reproducibility, and background fog changed at an acceptable level compared with the initial image.
D: Any of the evaluation items of image density, fine line reproducibility, and background fog apparently changed at an unacceptable level compared with the initial image.

### <Score on Comprehensive Evaluation>

Each evaluation result was scored on comprehensive evaluation as follows: A (3 points), B (2 points), C (1 point), and D (0 points). The higher score represents the better result.

### <Comprehensive Evaluation>

Evaluation was made based on the evaluation results and the scores for comprehensive evaluation as follows:

A: Comprehensive evaluation was scored as 26 points or more, and there was no items scored as D in the evaluation results
B: Comprehensive evaluation was scored as 19 points or more but less than 26 points or more, and there was no items scored as D in the evaluation results
C: Comprehensive evaluation was scored as less than 19 points or more, and there was no items scored as D in the evaluation results
D: Any of items was scored as D.

Evaluation results are presented in Tables 2-1 to 4-2.

TABLE 2-1

| | | | | | Seond | | |
|---|---|---|---|---|---|---|---|
| | | | | | most | | |
| | | | | Second | frequent | | |
| | Toner | | Most | most | diameter/ | | |
| | base | | frequent | frequent | Most | | Cir- |
| | par- | Sil- | diameter | diameter | frequent | Dv/ | cu- |
| | ticles | ica | μm | μm | diameter | Dn | larity |
| Ex. 1 | 1 | 6 | 5.2 | 6.3 | 1.21 | 1.09 | 0.98 |
| Ex. 2 | 2 | 6 | 5.2 | 6.5 | 1.25 | 1.11 | 0.98 |
| Ex. 3 | 3 | 6 | 5.2 | 6.5 | 1.31 | 1.15 | 0.99 |
| Ex. 4 | 4 | 6 | 5.2 | 6.5 | 1.25 | 1.11 | 0.98 |
| Ex. 5 | 2 | 1 | 5.2 | 6.5 | 1.25 | 1.11 | 0.99 |
| Ex. 6 | 2 | 2 | 5.2 | 6.5 | 1.25 | 1.11 | 0.98 |
| Ex. 7 | 2 | 3 | 5.2 | 6.5 | 1.25 | 1.11 | 0.98 |
| Ex. 8 | 2 | 4 | 5.2 | 6.5 | 1.25 | 1.11 | 0.98 |
| Ex. 9 | 2 | 3 | 5.2 | 6.5 | 1.25 | 1.11 | 0.99 |
| Ex. 10 | 2 | 5 | 5.2 | 6.5 | 1.25 | 1.11 | 0.98 |
| Comp. | 5 | 6 | 5.2 | No peak | — | 1.05 | 0.98 |
| Ex. 1 | | | | | | | |
| Comp. | 6 | 6 | 5.2 | 6.2 | 1.19 | 1.07 | 0.98 |
| Ex. 2 | | | | | | | |
| Comp. | 7 | 6 | 5.2 | 6.9 | 1.33 | 1.25 | 0.98 |
| Ex. 3 | | | | | | | |
| Comp. | 8 | 6 | 5.2 | 6.3 | 1.21 | 1.07 | 0.98 |
| Ex. 4 | | | | | | | |
| Comp. | 9 | 6 | 5.2 | 6.8 | 1.31 | 1.17 | 0.98 |
| Ex. 5 | | | | | | | |
| Comp. | 10 | 6 | 5.2 | 6.2 | 1.19 | 1.08 | 0.98 |
| Ex. 6 | | | | | | | |
| Comp. | 11 | 6 | 5.2 | 6.9 | 1.33 | 1.15 | 0.98 |
| Ex. 7 | | | | | | | |

TABLE 2-2

| | | | In silicone oil | | | |
|---|---|---|---|---|---|---|
| | | | treated external | | | |
| | Amount of | Amount of | additive added | | Total | Total |
| | external | HMDS | Total | Total | free | remaining |
| | additive | treated | free | remaining | PDMS | PDMS |
| | in Tables | external | PDMS | PDMS | amount | amount |
| | 1-1 and 1-2 | additive | amount | amount | in toner | in toner |
| | part | part | % by mass | % by mass | % by mass | % by mass |
| Ex. 1 | 3 | 1 | 0.000 | 0.000 | 0.000 | 0.000 |
| Ex. 2 | 3 | 1 | 0.000 | 0.000 | 0.000 | 0.000 |
| Ex. 3 | 3 | 1 | 0.000 | 0.000 | 0.000 | 0.000 |
| Ex. 4 | 3 | 1 | 0.000 | 0.000 | 0.000 | 0.000 |
| Ex. 5 | 3 | 1 | 0.250 | 0.060 | 0.240 | 0.058 |
| Ex. 6 | 3 | 1 | 0.330 | 0.250 | 0.317 | 0.240 |
| Ex. 7 | 3 | 1 | 0.410 | 0.210 | 0.394 | 0.202 |
| Ex. 8 | 3 | 1 | 0.510 | 0.080 | 0.490 | 0.077 |
| Ex. 9 | 4 | 1 | 0.547 | 0.280 | 0.521 | 0.267 |
| Ex. 10 | 3 | 1 | 0.110 | 0.170 | 0.106 | 0.163 |
| Comp. | 3 | 1 | 0.000 | 0.000 | 0.000 | 0.000 |
| Ex. 1 | | | | | | |
| Comp. | 3 | 1 | 0.000 | 0.000 | 0.000 | 0.000 |
| Ex. 2 | | | | | | |
| Comp. | 3 | 1 | 0.000 | 0.000 | 0.000 | 0.000 |
| Ex. 3 | | | | | | |
| Comp. | 3 | 1 | 0.000 | 0.000 | 0.000 | 0.000 |
| Ex. 4 | | | | | | |
| Comp. | 3 | 1 | 0.000 | 0.000 | 0.000 | 0.000 |
| Ex. 5 | | | | | | |
| Comp. | 3 | 1 | 0.000 | 0.000 | 0.000 | 0.000 |
| Ex. 6 | | | | | | |
| Comp. | 3 | 1 | 0.000 | 0.000 | 0.000 | 0.000 |
| Ex. 7 | | | | | | |

TABLE 3

| | Cleanabil- | Cleanabil- | Cleanabil- | Film | | |
|---|---|---|---|---|---|---|
| | ity of | ity of | ity of | abrasion | | Contamina- |
| | latent | latent | latent | amount | | tion of |
| | image | image | image | μm/2,000 | | regulation |
| | bearer 1 | bearer 2 | bearer 3 | sheets | | blade |
| Ex. 1 | C | C | C | 0.6 | C | A |
| Ex. 2 | B | B | B | 0.5 | C | A |
| Ex. 3 | B | C | C | 0.6 | C | A |
| Ex. 4 | B | B | C | 0.6 | C | A |
| Ex. 5 | A | A | B | 0.4 | B | A |
| Ex. 6 | A | A | A | 0.3 | A | B |
| Ex. 7 | A | A | A | 0.3 | A | B |
| Ex. 8 | A | A | A | 0.2 | A | B |
| Ex. 9 | A | A | A | 0.3 | A | C |
| Ex. 10 | B | C | C | 0.5 | C | A |
| Comp. | D | D | D | 1.8 | D | A |
| Ex. 1 | | | | | | |
| Comp. | C | D | D | 1.4 | D | A |
| Ex. 2 | | | | | | |
| Comp. | B | C | C | 0.6 | C | A |
| Ex. 3 | | | | | | |
| Comp. | C | D | D | 0.6 | C | A |
| Ex. 4 | | | | | | |
| Comp. | B | C | C | 0.6 | C | A |
| Ex. 5 | | | | | | |
| Comp. | D | D | D | 1.4 | D | A |
| Ex. 6 | | | | | | |
| Comp. | B | C | C | 0.6 | C | A |
| Ex. 7 | | | | | | |

TABLE 4-1

| | Cleability of | Cleability of | | |
|---|---|---|---|---|
| | intermediate | intermediate | Abrasion amount of | |
| | transfer | transfer | intermediate transfer member | |
| | member 1 | member 2 | streak/2,000 sheets | |
| Ex. 1 | C | C | 20 | C |
| Ex. 2 | C | C | 15 | C |
| Ex. 3 | C | C | 19 | C |
| Ex. 4 | C | C | 17 | C |
| Ex. 5 | B | C | 8 | B |
| Ex. 6 | A | B | 6 | B |
| Ex. 7 | A | A | 4 | A |
| Ex. 8 | A | A | 2 | A |
| Ex. 9 | A | A | 1 | A |
| Ex. 10 | C | C | 17 | C |
| Comp. Ex. 1 | D | D | 34 | D |
| Comp. Ex. 2 | D | D | 26 | D |
| Comp. Ex. 3 | C | C | 15 | C |
| Comp. Ex. 4 | C | D | 16 | C |
| Comp. Ex. 5 | C | C | 15 | C |
| Comp. Ex. 6 | D | D | 26 | D |
| Comp. Ex. 7 | C | C | 15 | C |

TABLE 4-2

| | Evaluation | Evaluation | Score on | |
|---|---|---|---|---|
| | of image | of image | comprehensive | Comprehensive |
| | stability 1 | stability 2 | evaluation | evaluation |
| Ex. 1 | A | A | 16 | C |
| Ex. 2 | A | A | 19 | B |
| Ex. 3 | B | B | 15 | C |
| Ex. 4 | B | B | 16 | C |
| Ex. 5 | A | A | 24 | B |
| Ex. 6 | A | A | 27 | A |
| Ex. 7 | A | A | 29 | A |
| Ex. 8 | A | A | 29 | A |
| Ex. 9 | B | C | 25 | B |
| Ex. 10 | A | A | 17 | C |
| Comp. Ex. 1 | C | C | 5 | D |
| Comp. Ex. 2 | C | C | 6 | D |
| Comp. Ex. 3 | D | D | 11 | D |
| Comp. Ex. 4 | C | C | 9 | D |
| Comp. Ex. 5 | C | D | 12 | D |
| Comp. Ex. 6 | C | C | 5 | D |
| Comp. Ex. 7 | C | D | 12 | D |

It can be seen from the evaluation results presented in these tables that the developers of Examples produced using the toners according to the present invention are more excellent than the developers of Comparative Examples in the cleanability and the abrasion amount.

Aspects of the present invention are, for example, as follows:

<1> A toner including:
a binder resin; and
a release agent,
wherein the toner has a second peak particle diameter in a range of from 1.21 times through 1.31 times as large as a most frequent diameter in a volume basis particle size distribution of the toner, and
wherein the toner has a particle size distribution (volume average particle diameter/number average particle diameter) in a range of from 1.08 through 1.15.
<2> The toner according to <1>,
wherein the toner has the second peak particle diameter in a range of from 1.25 times through 1.31 times as large as the most frequent diameter in the volume basis particle size distribution of the toner.
<3> The toner according to <1> or <2>,
wherein the toner has average circularity in a range of from 0.98 through 1.00.
<4> The toner according to any one of <1> to <3>,
wherein the toner includes a silicone-oil-treated external additive.
<5> The toner according to <4>,
wherein a total amount of free silicone oil in the toner is in a range of from 0.20% by mass through 0.50% by mass relative to the toner.
<6> The toner according to <4> or <5>,
wherein the external additive includes silicone oil in an amount of from 2 mg through 10 mg per m² of surface area of the external additive.
<7> An image forming apparatus including:
a primary transfer means configured to transfer a visible image, which has been formed on a surface of a latent image bearer with a toner, onto an intermediate transfer member;
a toner removing means configured to remove a toner, which remains on the surface of the latent image bearer after the transfer, with a cleaning blade for a latent image bearer;
a secondary transfer means configured to transfer the visible image from the intermediate transfer member to a transferred medium; and
a toner removing means for an intermediate transfer member, the toner removing means being configured to remove a toner, which remains on the intermediate transfer member after the transfer, with a cleaning blade for an intermediate transfer member,
wherein the toner is the toner according to any one of <1> to <6>.
<8> The image forming apparatus according to <7>,
wherein the cleaning blade for a latent image bearer has rebound resilience in a range of from 10% through 35%,
wherein the cleaning blade for a latent image bearer is configured to be brought into contact with the latent image bearer at pressure in a range of from 20 N/m through 50 N/m, and
wherein the cleaning blade for a latent image bearer is brought into contact with the latent image bearer at a contact angle θ in a range of from 70° through 82°, the contact angle θ being formed between an end surface of the cleaning blade for a latent image bearer and a tangential line extended from a point at which the cleaning blade for a latent image bearer is brought into contact with the surface of the latent image bearer.
<9> The image forming apparatus according to <7>,
wherein the cleaning blade for an intermediate transfer member has rebound resilience in a range of from 35% through 55%,
wherein the cleaning blade for an intermediate transfer member is configured to be brought into contact with the intermediate transfer member at pressure in a range of from 20 N/m through 50 N/m, and
wherein the cleaning blade for an intermediate transfer member is brought into contact with the intermediate transfer member at a contact angle θ in a range of from 70° through 82°, the contact angle θ being formed between an end surface of the cleaning blade is for an intermediate transfer member and a tangential line extended from a point at which the cleaning blade for an intermediate transfer member is brought into contact with the surface of the intermediate transfer member.
<10> A process cartridge including:
a latent image bearer; and
a developing means configured to develop, with a toner, an electrostatic latent image on the latent image bearer,
wherein the latent image bearer and the developing means are integratedly supported, and
wherein the process cartridge is detachably mounted in the image forming apparatus according to any one of <7> to <9>.

### REFERENCE SIGNS LIST

1 toner producing apparatus
2 liquid droplet discharging means
9 elastic plate
10 liquid column resonance liquid droplet discharging unit
11 liquid column resonance liquid droplet discharging means
12 gas stream path
13 raw material container
14 toner component liquid
15 liquid circulating pump
16 liquid supplying pipe
17 common liquid supplying path
18 liquid column resonance liquid chamber
19 discharge hole
20 vibration generating means
21 liquid droplet
22 liquid returning pipe
60 drying/collecting unit
61 chamber
62 solidified particle collecting means
63 solidified particle storing portion
64 conveying gas stream inlet port
65 conveying gas stream outlet port
101 latent image bearer
102 charging device
103 exposure device
104 developing device
105 cleaning portion
105b cleaning blade
105b-1 plate cleaning blade
105b-2 supporting member
105c toner collecting case
105d rocking lever shaft
105e movable member
105f tension spring
105g screw
106 intermediate transfer member
107 support roller
108 transfer roller
109 heating roller
100 aluminium cored bar
111 elastic body layer
112 PFA surface layer
113 heater
114 pressing roller
115 aluminium cored bar
116 elastic body layer
117 PFA surface layer
118 unfixed image
119 fixed image
120 cleaning blade for intermediate transfer member
140 developing roller
141 thin layer-forming member
142 supplying roller
502 toner
503 stopper layer
1001 conveying gas stream
L exposure
P recording paper
T toner for developing electrostatic image
θ contact angle
P1: pressure gauge for liquid
P2: pressure gauge for inside chamber

1. A toner comprising:
a binder resin; and
a release agent,
wherein the toner has a second peak particle diameter in a range of from 1.21 times through 1.31 times as large as a most frequent diameter in a volume basis particle size distribution of the toner, and
wherein the toner has a particle size distribution (volume average particle diameter/number average particle diameter) in a range of from 1.08 through 1.15.

2. The toner according to claim 1, wherein the toner has the second peak particle diameter in a range of from 1.25 times through 1.31 times as large as the most frequent diameter in the volume basis particle size distribution of the toner.

3. The toner according to claim 1, wherein the toner has average circularity in a range of from 0.98 through 1.00.

4. The toner according to claim 1, wherein the toner comprises a silicone-oil-treated external additive.

5. The toner according to claim 4, wherein a total amount of free silicone oil in the toner is in a range of from 0.20% by mass through 0.50% by mass relative to the toner.

6. The toner according to claim 4, wherein the external additive comprises silicone oil in an amount of from 2 mg through 10 mg per m² of surface area of the external additive.

7. An image forming apparatus comprising:
a primary transfer means configured to transfer a visible image, which has formed on a surface of a latent image bearer with a toner, onto an intermediate transfer member;
a toner removing means configured to remove a toner, which remains on the surface of the latent image bearer after the transfer, with a cleaning blade for a latent image bearer;
a secondary transfer means configured to transfer the visible image from the intermediate transfer member to a transferred medium; and
a toner removing means for an intermediate transfer member, the toner removing means being configured to remove a toner, which remains on the intermediate transfer member after the transfer, with a cleaning blade for an intermediate transfer member,
wherein the toner is a toner comprising: a binder resin; and a release agent,
wherein the toner has a second peak particle diameter in a range of from 1.21 times through 1.31 times as large as a most frequent diameter in a volume basis particle size distribution of the toner, and
wherein the toner has a particle size distribution (volume average particle diameter/number average particle diameter) in a range of from 1.08 through 1.15.

8. The image forming apparatus according to claim 7, wherein the cleaning blade for a latent image bearer has rebound resilience in a range of from 10% through 35%, wherein the cleaning blade for a latent image bearer is configured to be brought into contact with the latent image bearer at pressure in a range of from 20 N/m through 50 N/m, and wherein the cleaning blade for a latent image bearer is brought into contact with the latent image bearer at a contact angle θ in a range of from 70° through 82°, the contact angle θ being formed between an end surface of the cleaning blade for a latent image bearer and a tangential line extended from a point at which the cleaning blade for a latent image bearer is brought into contact with the surface of the latent image bearer.

9. The image forming apparatus according to claim 7, wherein the cleaning blade for an intermediate transfer member has rebound resilience in a range of from 35% through 55%, wherein the cleaning blade for an intermediate transfer member is configured to be brought into contact with the intermediate transfer member at pressure in a range of from 20 N/m through 50 N/m, and wherein the cleaning blade for an intermediate transfer member is brought into contact with the intermediate transfer member at a contact angle θ in a range of from 70° through 82°, the contact angle θ being formed between an end surface of the cleaning blade for an intermediate transfer member and a tangential line extended from a point at which the cleaning blade for an intermediate transfer member is brought into contact with the surface of the intermediate transfer member.

10. A process cartridge comprising:
a latent image bearer; and
a developing means configured to develop, with a toner, an electrostatic latent image on the latent image bearer,
wherein the latent image bearer and the developing means are integratedly supported, and
wherein the process cartridge is detachably mounted in an image forming apparatus,
wherein the image forming apparatus is an image forming apparatus comprising: a primary transfer means configured to transfer a visible image, which has formed on a surface of a latent image bearer with a toner, onto an intermediate transfer member;
a toner removing means configured to remove a toner, which remains on the surface of the latent image bearer after the transfer, with a cleaning blade for a latent image bearer;
a secondary transfer means configured to transfer the visible image from the intermediate transfer member to a transferred medium; and
a toner removing means for an intermediate transfer member, the toner removing means being configured to remove a toner, which remains on the intermediate transfer member after the transfer, with a cleaning blade for an intermediate transfer member,
wherein the toner is a toner comprising: a binder resin; and a release agent,
wherein the toner has a second peak particle diameter in a range of from 1.21 times through 1.31 times as large as a most frequent diameter in a volume basis particle size distribution of the toner, and
wherein the toner has a particle size distribution (volume average particle diameter/number average particle diameter) in a range of from 1.08 through 1.15.

11. The image forming apparatus according to claim 7,
wherein the toner has the second peak particle diameter in a range of from 1.25 times through 1.31 times as large as the most frequent diameter in the volume basis particle size distribution of the toner.

12. The image forming apparatus according to claim 7, wherein the toner has average circularity in a range of from 0.98 through 1.00.

13. The image forming apparatus according to claim 7, wherein the toner comprises a silicone-oil-treated external additive.

14. The image forming apparatus according to claim 7, wherein a total amount of free silicone oil in the toner is in a range of from 0.20% by mass through 0.50% by mass relative to the toner.

15. The image forming apparatus according to claim 7, wherein the external additive comprises silicone oil in an amount of from 2 mg through 10 mg per m² of surface area of the external additive.

16. The process cartridge according to claim 10, wherein the toner has the second peak particle diameter in a range of from 1.25 times through 1.31 times as large as the most frequent diameter in the volume basis particle size distribution of the toner.

17. The process cartridge according to claim 10, wherein the toner has average circularity in a range of from 0.98 through 1.00.

18. The process cartridge according to claim 10, wherein the toner comprises a silicone-oil-treated external additive.

19. The process cartridge according to claim 10, wherein a total amount of free silicone oil in the toner is in a range of from 0.20% by mass through 0.50% by mass relative to the toner.

20. The process cartridge according to claim 10, wherein the external additive comprises silicone oil in an amount of from 2 mg through 10 mg per m² of surface area of the external additive.
